(19) United States
(12) Patent Application Publication
(10) Pub. No.: US 2007/0252927 A1
(43) Pub. Date: Nov. 1, 2007

(54) Transreflective liquid crystal display

(75) Inventors: Mitsuyoshi Ichihashi, Minami-ashigara-shi (JP); Hisashi Okamura, Minami-ashigara-shi (JP); Morimasa Sato, Fujinomiya-shi (JP); Shinichi Morishima, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/715,403

(22) Filed: Mar. 8, 2007

(30) Foreign Application Priority Data
Mar. 10, 2006 (JP) 2006-065881

(51) Int. Cl. G02F 1/1335

(52) U.S. Cl. 349/106

(57) ABSTRACT

A novel liquid crystal display is disclosed. The liquid crystal display comprises a backlight, a pair of substrates, a liquid crystal layer disposed between the pair of substrates, a color filter, reflective portions, transmissive portions, and a retardation layer disposed between the pair of substrates in each of the transmissive portions. The retardation layer comprises a liquid crystal material fixed in a hybrid state, and the retardation layer has a retardation which varies depending on a wavelength of the color filter.

This application claims benefit of priority under 35 U.S.C. 119 to Japanese Patent Application No. 2006-065881 filed Mar. 10, 2006.

### BACKGROUND OF THE INVENTION

1. Field of the Invention

The present invention relates to liquid crystal displays such as transreflective and semi-transmissive liquid crystal displays to be employed in various office automation equipments, portable game machines, mobile phones and mobile terminals.

2. Related Art

The liquid crystal display (LCD) technology includes major three types, the transmissive type capable of displaying images in a transmissive mode, the reflective type capable of displaying images in a reflective mode, and the transreflective type capable of displaying images in both of transmissive and reflective modes. The LCDs share a similar feature of having a slim and lightweight body, and have been employed widely as a display panel of notebook-size personal computers and TVs. Especially, the transreflective LCD, employing both of the reflective and the transmissive modes, can display clear images in both of bright and dark places by switching to either of the modes depending on ambient brightness, and has been used in various mobile electronic equipments.

FIG. 5 is a rough schematic drawing of one example of a conventional transreflective liquid crystal display. In FIG. 5, the LCD is observed from the upper-side, namely, the upper-side is the observed-side. Although a backlight is usually disposed at the downside, it is omitted from FIG. 5 for simplification.

According to the reflective mode, incident light from the upper side goes through the retardation film 2, thereby to be changed in its polarization state to a circular polarization state, after that, goes through the liquid crystal layer, and is reflected by a reflection plate such as an aluminum or silver plate to come back to the observer side through the liquid crystal layer. Usually, in the conventional reflective mode, the in-plane retardation of the liquid crystal layer is adjusted to equal to or less than 50 nm in the black state, and is adjusted to equal to or more than 100 nm in the white state. When circular polarized light is reflected by a reflecting plate, the sense of circular polarized light is reversed; and, thus, reflected light is blocked by a polarizing plate in the black state. On the other hand, in the white state, light going through the liquid crystal layer has a circular polarization state nearly equal to that of incident light; and the circular polarized light is changed to a linear polarized light by going through the retardation film. As a result, linear polarized light can go through the polarizing plate in the white state.

According to the transmissive mode, incident light from the backlight-side goes through the retardation film 11, thereby to be changed in its polarization state to a circular polarization state, after that, goes through the liquid crystal layer, and arrives at the polarizing plate. The sense of circular polarized light coming from the retardation film 11 is predetermined to be opposite to the sense of circular polarized light coming from the retardation film 2. In the black state, incident light goes through the retardation film 2 while maintaining its polarization state, and is blocked by the polarizing plate. In the white state, incident light goes through the liquid crystal layer in each transmissive portion, of which retardation is about a half-wavelength because of which thickness is about two times as length as the thickness of the liquid crystal layer in each reflective portion, so that the circular polarization state is reversed. As a result, light is not blocked by the polarizing plate in the white state.

The basic construction of the transreflective liquid crystal display is described in JPA Nos. 2000-29010 and 2000-35570.

However, according to the conventional transreflective mode, the retardation films 2 and 11 are required to exhibit λ/4 in any visible light wavelengths in order to avoid the coloring or the reduction in the transmissivity or reflectivity. This is why the conventional transreflective type LCD comprises a combination of a λ/4 layer and a λ/2 layer as a retardation film. However, such a conventional transreflective type LCD needs a total of four retardation films, each of which is disposed on or under the liquid crystal cell. And such a conventional transreflective type LCD also suffers from narrow viewing angle property.

Regarding to the transmissive mode, in order to improve the viewing-angle properties, it has been proposed that an optical compensation film, a nematic hybrid alignment film, is employed in the place of both of or either of λ/4 layers disposed on or under the liquid crystal cell. And some types of such optical compensation film have been actually used. The techniques are disclosed, for example, in JPA Nos. 2002-31717, 2004-157453, 2005-62672, and 2005-62670.

In order to reduce the number of the retardation films, it has been proposed that the retardation films are disposed inside of the liquid crystal cell in each reflective portion (JPA No. 2003-322857).

In order to improve brightness, especially peak brightness, in the transmissive mode, it has been also proposed that retardation films are disposed in each reflective portion inside of the liquid crystal cell (JPA Nos. 2004-38205, 2004-219553, 2004-226829, 2004-226830, 2005-242031, 2005-283850 and 2005-283851).

In order to improve peak brightness, it has been also proposed that retardation films are disposed in each transmissive portion inside of the liquid crystal cell (JPA No. 2004-145327).

However, it is very difficult to produce the retardation films uniformly and to reduce light scattering. And it is also difficult to balance the improvement in viewing angle property and the improvement in light use efficacy.

### SUMMARY OF THE INVENTION

One object of the present invention is to provide a transreflective type liquid crystal display, which can display images in both of reflective and transmissive modes, capable of displaying high brightness images with a wide-viewing angle; and excellent in productivity.

In one aspect, the invention provides a liquid crystal display comprising:

a backlight,

a pair of substrates,

a liquid crystal layer disposed between the pair of substrates,

a color filter,

reflective portions, transmissive portions, and

a retardation layer disposed between the pair of substrates in each of the transmissive portions,

wherein the retardation layer comprises a liquid crystal material fixed in a hybrid state, and the retardation layer has a retardation which varies depending on a wavelength of the color filter.

As embodiments of the invention, there are provided the liquid crystal display, wherein a phase angle of the retardation layer ranges from 50° to 130° depending on a wavelength of the color filter; the liquid crystal display, wherein the retardation layer has a first surface and a second surface, the first one being closer to one of the pair of substrates than the second one; and a tilt angle of the retardation layer increases along a direction going from the first surface to the second surface; and the liquid crystal display, wherein the retardation layer has a first surface and a second surface, the first one being closer to one of the pair of substrates than the second one; and a tilt angle of the retardation layer decreases along a direction going from the first surface to the second surface.

According to the invention, the retardation layer may be disposed on one of the pair of the substrates, being closer to a backlight than another of the pair of the substrates, or may be disposed on one of the pair of the substrates, being closer to an observer side than another of the pair of the substrates.

According to the invention, the retardation layer may be formed by fixing a nematic liquid crystal composition comprising a rod-like liquid crystal compound in a hybrid alignment state with a mean tilt angle ranging from 10 to 55°, may be formed by fixing a smectic liquid crystal composition comprising a rod-like liquid crystal compound in a hybrid alignment state with a mean tilt angle ranging from 10 to 55°, or may be formed by fixing a nematic liquid crystal composition comprising a discotic liquid crystal compound in a hybrid alignment state with a mean tilt angle ranging from 35 to 85°.

According to the invention, the retardation layer may be formed of a polymerizable composition comprising a polymerizable liquid crystal compound having a polymerizable group(s). The conversion of the polymerizable group(s) of the liquid crystal compound is preferably equal to or more than 85%. The retardation layer may also be formed of a fluid comprising a liquid crystal compound, which is ejected from an ink-jet type head to each of the transmissive portions, dried to form a liquid crystal phase, and irradiated with light; or may be formed of a fluid comprising a liquid crystal compound, which is ejected from an ink-jet type head to each of the transmissive portions, having a black matrix thereon, dried to form a liquid crystal phase, and irradiated with light.

In one embodiment of the invention, a mean tilt angle of liquid crystal molecules in the liquid crystal layer in a black state is larger than that in a white state.

In one embodiment of the invention, a mean direction of directors of liquid crystal molecules in the liquid crystal layer projected on to a layer plane is substantially parallel to a mean direction of directors of liquid crystal molecules fixed in a hybrid alignment state in the retardation layer projected on to a layer plane.

### BRIEF DESCRIPTION OF THE DRAWINGS

FIG. 1 is a rough schematic drawing of one example of the transreflective liquid crystal display of the invention.

FIG. 2 is a rough schematic drawing of another example of the transreflective liquid crystal display of the invention.

FIG. 3 is a rough cross-sectional drawing of another example of a substrate employed in the liquid crystal display of the invention.

FIG. 4 is a rough schematic drawing showing one example of a flow of the process for producing a retardation layer and color filter layer.

FIG. 5 is a rough schematic drawing of one example of a conventional transreflective liquid crystal display.

In these drawings, reference numerals mean as follows:
1 an observer-side polarizing plate (front side)
2 a retardation film
3 a substrate
4 a color filter on a transmissive area
5 a color filter on a reflective area
6 a black matrix
7 an overcoat layer
8 a liquid crystal layer
9 a reflecting plate
11 a retardation film
12 a backlight-side polarizing plate
13 a hybrid-alignment retardation layer

### PREFERRED EMBODIMENT OF THE INVENTION

The present invention will be described in detail.

It is to be noted, in this description, that the term “ . . . to . . . ” is used as meaning a range inclusive of the lower and upper values disposed therebefore and thereafter.

It is to be noted that, regarding angles, the term “vertical” or “parallel” in the context of this specification means that a tolerance of less than +10° with respect to the precise angles can be allowed.

In this specification, Re(λ) and Rth(λ) represent in-plane retardation and thickness-wise retardation at wavelength λ, respectively.

The Re(λ) is measured by using KOBRA-21ADH (manufactured by Oji Scientific Instruments) for an incoming light of a wavelength λ nm in a vertical direction to a film-surface. The Rth(λ) is calculated by using KOBRA-21ADH based on the Re(λ) value and plural retardation values which are measured for incoming light of a wavelength λnm in three directions, one of which is a normal direction of the film and two of which are directions rotated by −40° and +400 respectively with respect to the normal direction of the film using an in-plane slow axis, which is decided by KOBRA-21ADH, as an a tilt axis (a rotation axis). In the above-described measurement, the hypothetical value of mean refractive index is available from values listed in catalogues of various optical films in Polymer Handbook (John Wiley & Sons, Inc.). Those having the mean refractive indices unknown can be measured using an Abbe refract meter. Mean refractive indices of some major optical films are listed below:

Cellulose acylate (1.48), cycloolefin polymer (1.52), polycarbonate (1.59), polymethylmethacrylate (1.49) andpolystyrene (1.59).

In this specification, an in-plan retardation Re and a thickness direction retardation Rth are values measured at λ=550 nm.

In this specification, λ is 650±40 nm, 550±10 nm and 450±20 nm for R, G and B, respectively, if no specific description is made on color.

It is also to be noted that the term “visible light” in the context of this specification means light of a wavelength falling within the range from 400 to 700 nm.

In this specification, the term “tilt angle” means an angle between a layer plane and a liquid crystal molecule aligned in a tilted nematic alignment state, and also means a maximum angle among the angles between a layer plane and directions of the maximum refractive index in a refractive-index ellipsoidal body of a liquid crystal molecule. For example, regarding to positive optical anisotropic rod-like liquid crystal molecules, the term “tilt angle” means an angle between a long axis of a molecule, or, in other words, a director, and a layer plane; and regarding to negative optical anisotropic discotic liquid crystal molecules, the term “tilt angle” means an angle between a discotic plane of a molecule and a layer plane.

In this specification, the term “mean tilt angle” means an average value of the tilt angles at the upper-side interface and at the downside interface of a layer. A mean tilt angle found in a uniform tilt alignment state is same as a tilt angle at the upper-side interface and at the downside interface; and a mean tilt angle found in a hybrid alignment state is same as an intermediate value of the tilt angles at the upper-side interface and at the downside interface.

[Construction of Liquid Crystal Display of the Invention]

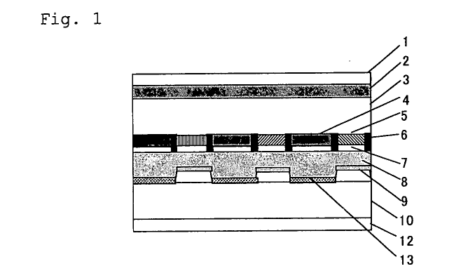

One construction example of the liquid crystal display of the invention will be described while referring to FIG. 1.

FIG. 1 is a rough schematic drawing of one example of the transreflective liquid crystal display (LCD) of the invention. The transreflective liquid crystal display shown in FIG. 1 comprises reflective portions and transmissive portions. The LCD comprises an observer-side polarizing plate 1, a retardation plate 2, a substrate 3, a transmissive portion color filter 4, a reflective portion color filter 5, a black matrix 6, an overcoat layer 7 and a liquid crystal layer 8 having two different thickness between in the reflective and transmissive portions, a reflecting plate 9 such as an aluminum plate, a hybrid-alignment retardation layer 13, a substrate 10, and a backlight-side polarizing plate 12, which are aligned in this order from the observer side. Although not shown in FIG. 1, the LCD may further comprise a backlight unit comprising a light source, a light guide plate, a prism sheet and a diffuser plate, and a reflecting plate disposed at a back face of the light guide plate, under the backlight-side polarizing plate 12. If necessary, the LCD may further comprise a polarizing-reflecting plate consisting of a birefringent layer and a isotropic refractive layer with a optical thickness of λ/4, or a polarizing-reflecting plate consisting of a cholesteric liquid crystal film and a λ/4 retardation plate, between the backlight-side polarizing plate 12 and the backlight unit.

Outside light goes through the observer-side polarizing plate 1 and the retardation plate 2, thereby to be changed in its polarization state nearly equal to a circular polarization state, goes through the liquid crystal layer 8, is reflected by the reflecting plate 2, and goes through the liquid crystal layer 8 again. According to this process, the polarization state of the reflection light varies depending on the voltage value applied to the liquid crystal layer 8, and, therefore, the strength of light coming from the observer-side polarizing plate 1 to outside can be modulated.

On the other hand, incident light from the backlight goes through the backlight-side polarizing plate 12, thereby to be changed in its polarization state to a linear polarization state, and, then, goes through the substrate 10. Apart of the light from the substrate 10 goes through the hybrid-alignment retardation layer 13, which is disposed in each transmissive portion, thereby to be changes in its polarization state to a circular polarization state. The circular polarization light goes through the liquid crystal layer, thereby to be changed in its polarization state by the birefringence of the liquid crystal layer 8 which is developed by the application of voltage. After going through the color filter 4 in each transmissive portion, the light goes though the retardation plate 2, thereby to be changed in its polarization state again, and, then, depending on its polarization state, is blocked by the polarizing plate 1 or passes into the polarizing plate 1.

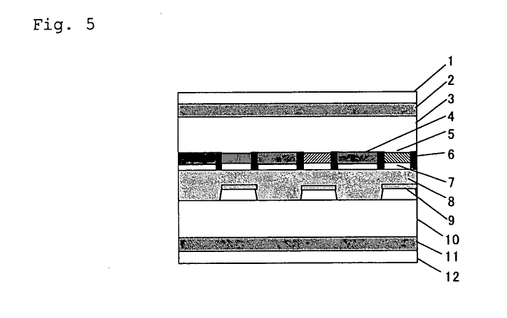

Another light from the substrate 10 is reflected by the back surface of the reflecting plate 9. As shown in FIG. 5, according to a conventional LCD, the reflected light goes trough a retardation film 11, thereby to be changed in its polarization state by 180°, and, therefore, the light is absorbed by the backlight-side polarizing plate 12.

According to the embodiment of the invention, no retardation film is required to be disposed between the reflecting plate 9 and the backlight-side polarizing plate 12; and, therefore, the reflected light is not changed in its polarization state and is not absorbed by the backlight-side polarizing plate 12. The reflected light can come back to the backlight unit and be recycled.

The retardation of the hybrid-alignment retardation layer 13 in each transmissive portion is adjusted so as to have a retardation corresponding to the transmission wavelength of the color filter 4 disposed in the transmissive portion by controlling the thickness of each hybrid-alignment retardation layer 13 or the birefringent ratio of the material to be used for preparation.

According to the invention, the phase angle difference found in the hybrid-alignment retardation layer corresponding to each color is preferably nearly equal to each other.

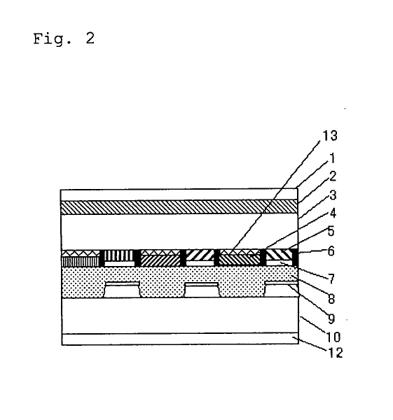

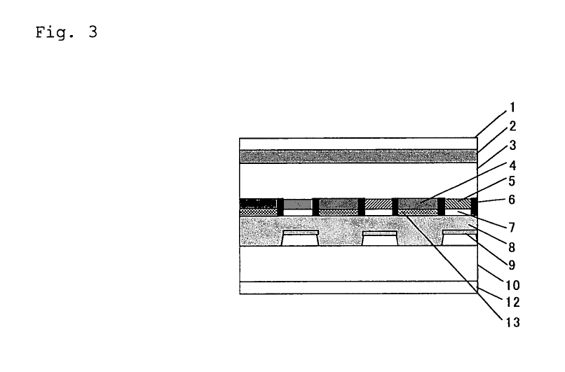

In another embodiment of the invention, the hybrid-alignment retardation layer 13 may be disposed between the transmissive color filter 4 and the observer-side substrate 3 or between the transmissive color filter 4 and the liquid crystal layer 8, as shown in FIGS. 2 and 3.

In these embodiments, the unevenness may be generated since the fine retardation layers having a different thickness each other are formed on a same surface of the substrate, or the fine retardation layers are formed on a part of a surface of the substrate. And, if necessary, in order to planarize the uneven surface, a polish treatment may be carried out or an overcoat layer may be formed on the surface.

[Substrate]

According to the invention, the substrate having the hybrid-alignment retardation layer and the color filter layer thereon can be selected from various materials employed as a substrate of a liquid crystal cell without any limitations. Examples of the substrate include metal substrates, substrates having a metal layer thereon, glass substrates, ceramic substrates and polymer films. In terms of the transparency and the dimension stability, glass substrates and polymer films are preferably used.

[Liquid Crystal Layer]

Examples of the operating alignment mode of the liquid crystal layer employed in the invention include a TN (Twisted Nematic) mode, STN(SuperTwisted Nematic) mode, ECB(Electrically Controlled Birefringence) mode, IPS(In-Plane Switching) mode, VA(Vertical Alignment) mode, MVA(Multidomain Vertical Alignment) mode, PVA(Patterned Vertical Alignment) mode, OCB(Optically Compensated Birefringence) mode, HAN(Hybrid Aligned Nematic) mode, ASM(Axially Symmetric Aligned Microcell) mode, half-tone gray scale mode, divided-domain mode, and modes employing dielectric or antiferroelectric liquid crystal. The driving mode employed in the invention is not limited too, and examples of the driving mode include a passive-matrix mode employed in STN-LCDs or the like, an active-matrix mode employing an active electrode such as a TFT (Thin Film Transistor) electrode and a TFD(Thin Film Diode) electrode, and a plasma-addressing mode.

The modes, in which tilt angle of liquid crystal in the black state is larger than that in the white state, such as VA mode, MVA mode, PVA mode, OCB mode, HAN mode and ASM mode are preferably employed in the liquid crystal display of the invention.

[Observer-Side Retardation Film]

The liquid crystal display of the invention may comprise a wide-range λ/4 plate disposed between the observer-side polarizing plate and the liquid crystal cell. The wide-range λ/4 plate is employed for changing elliptic polarization light, going through the liquid crystal cell, into linear polarization light effectively. In order to achieve the wide-range ability, a mono-layer film or multi-layer films such as any combinations of films having a different retardation and any combinations of films having a slow axis in a different direction each other may be used as a wide-range λ/4 plate. In order to obtain the wide-range ability, optical films having a small wavelength-dependency of the retardation are preferably as a λ/4 plate. The materials of the λ/4 plate are not limited, and the λ/4 plate can be selected from liquid crystal films and stretched polymer films. Examples of the stretched polymer films include stretched films of polymers, having monoaxiality or biaxiality, such as polycarbonates(PC), polymethacrylates(PMMA), poly vinyl alcohols(PVA) and norbornene-based polymers. In terms of small wavelength-dependency of retardation, the films are prepared by stretching ARTON (manufacture by JSP). Examples of the combination of plural retardation plates capable of functioning as a circular polarizing plate for a whole visible-light wavelength region, or, in other words, as a wide-range λ/4 plate, include a combination of a retardation plate having a λ/4 phase difference and a retardation plate having a λ/2 phase difference in which the angle between their slow axes is 60°; a combination of a retardation plate having a λ/4 phase difference and a linear polarizing film in which the angle between the slow axis of the retardation plate and the transmission axis (an in-plane direction giving a maximum transmission) is 75°; and a combination a retardation plate having a λ/2 phase difference a linear polarizing film in which the angle between the slow axis of the retardation plate and the transmission axis is 150. For the combination of a λ/4 phase difference plate and a linear polarizing film, the angle between the slow axis and the transmission axis can be 15′; and for the combination of a λ/2 phase difference plate and a linear polarizing film, the angle between the slow axis and the transmission axis can be 75°. The allowable difference of the angle is ±10°, preferably ±8°, more preferably ±6°, much more preferably +5°, and further much more preferably ±40.

[Color Filter Layer]

A color filter, generally, comprises R, G and B color filter layers and a black matrix capable of blocking the light. According to the invention, the black matrix may function as a barrier wall dividing the color filter layers into fine areas (for example pixels).

According to a transreflective LCD, the light goes through the color filter layers twice times in each reflective portion; and it is preferable that the color filter layers disposed in each reflective portion have an absorption concentration which are lower than those found in the color filter layers disposed in each transmissive portion. The color filter layers disposed in each reflective portion may be produced using materials having an absorption concentration which is lower than that of the materials to be used for producing the color filter layers disposed in each transmissive portion. The difference in absorption concentration between the color filter layers disposed in each reflective portion and in each transmissive portion can also be created by forming first color filter layers in both of reflective and transmissive portions, and forming second color filter layers on areas corresponding to the transmissive portions on the first color filter layers.

The color filter layers can be produced by ejecting a colored composition using an ink jet apparatus to each fine area separated by the barrier wall (a black matrix). The color filter layers can also be produced according to a method comprising plurality of coating a colored composition, irradiating with patterned light and developing the composition. If necessary, an overcoat layer may be formed on the color filter layers. The overcoat layer may contribute to improving the surface-flatness, the humidity resistance and the chemical resistance of the color filter layers. The overcoat layer may also contribute to improving the barrier property capable of preventing the outflow of ingredients in the color filter layers. Preferable examples of the material to be used for preparing the overcoat layer include transparent polymer materials such as thermal curable acryl-based copolymers containing maleimide, and epoxy resin compositions.

[Barrier Wall]

In the invention, the substrate may have the barrier wall separating respective fine areas (e.g., respective pixel domains). The barrier wall having light-shielding properties can be used as a black matrix (hereinafter, a barrier wall that also functions as a black matrix is referred to as a “light-shielding barrier wall”), which is preferred because the construction, producing method etc. can be simplified. The light-shielding barrier wall may be produced, for example, by using a colorant-containing photosensitive composition with deep color (hereinafter, occasionally referred to as a “deep color composition”). Here, the deep color composition means a composition having a high optical density, the value of which is from 2.0 to 10.0. The deep color composition has an optical density of preferably from 2.5 to 6.0, particularly preferably from 3.0 to 5.0. Further, since the deep color composition is preferably cured by a photo-initiation system as described later, an optical density for an exposing wavelength (generally in an ultraviolet region) is also important. That is, the value is from 2.0 to 10.0, preferably from 2.5 to 6.0, most preferably from 3.0 to 5.0. The value less than 2.0 may result in an unintended figure of the barrier wall and, on the other hand, the value more than 10.0 does not allow the polymerization to begin and it is difficult to form the barrier wall itself. When a colorant only has such properties, the colorant (deep color body) in a composition may be an organic material (coloring agent such as dye or pigment), each of carbons in respective configurations, or one composed of a combination thereof.

The height of the light-blocking barrier wall preferably ranges from 1 to 20 μm, more preferably from 1.5 to 10 μm and much more preferably from 2 to 5 μm in terms of avoiding color mixture.

For producing such light-shielding barrier wall easily and at low cost, there is such technique as using a photosensitive transfer material having at least a layer composed of a photosensitive deep color composition and an oxygen-blocking layer in this order on a temporary support. When such material is used, since the layer composed of the photosensitive deep color composition is protected by the oxygen-blocking layer, it lies automatically in a poor-oxygen atmosphere. Therefore, there is such advantage that the exposure process is not required to be carried out under an inert gas or reduced pressure, thereby making it possible to utilize the current process without change.

[Hybrid-Alignment Retardation Layer]

The hybrid-alignment retardation layer, which can be used in the invention, is a layer in which liquid crystal molecules are fixed in a hybrid-alignment state. In the hybrid alignment state, the tilt angles of liquid crystal molecules at an upper-side interface and at a downside interface are different each other; and, in particular, the difference between the tilt angles found at the upper-side interface and at the downside interface of the layer is equal to or more than 5°. It is preferable that the tilt angle varies continuously from one interface to another interface of the layer. There are two embodiments of the hybrid-alignment, in one of which the tilt angle increases along a direction going from the substrate-side interface to another interface, and in another of which the tilt angle decreases along a direction going from the substrate-side interface to another interface. Both can bring about the effect of the invention, and be employed in the invention. Regarding to rod-like liquid crystal molecules, the absolute value of the mean tilt angle preferably ranges from 10° to 55°, more preferably from 20° to 45°, and much more preferably from 25° to 40°. On the other hand, regarding to discotic liquid crystal molecules, the absolute value of the mean tilt angle preferably ranges from 35° to 85°, more preferably from 40° to 80°, and much more preferably from 45° to 70°. When a hybrid-alignment retardation layer with a mean tilt angle falling without the preferable range is employed in the invention, the contrast may sometimes decrease or the viewing angle range generating the gray-scale inversion may sometimes expand.

It is to be noted that a mean tilt angle can be measured according to a modified crystal rotation method.

It is also to be noted that, according to the invention, the hybrid-alignment retardation layer is not required to comprise a liquid crystal compound although it is produced by using a liquid crystal compound. In the layer, liquid crystal molecules are fixed in a state by polymerization or the like, and may lose their liquid crystallinity.

It is also to be noted that the hybrid-alignment retardation layer has no optical axis as a whole since the directors of liquid crystal molecules are random in any positions of the thickness direction.

The hybrid-alignment retardation layer can be produced by stabilizing nematic liquid crystal molecules in a hybrid alignment state with a mean tilt angle falling within the above mentioned range. The material and the stabilizing process employed in producing the retardation layer is not limited. For example, the retardation layer can be produced according to the method comprising aligning low-molecular weight liquid crystal in a hybrid alignment state and stabilizing the hybrid alignment by photo-crosslinking or thermal-crosslinking. The retardation layer can also be produced according to the method comprising aligning high-molecular weight liquid crystal in a hybrid alignment state and stabilizing the hybrid alignment by cooling.

The hybrid-alignment retardation layer may be produced by using smectic liquid crystal. For example, the hybrid-alignment retardation layer can be produced according to the method comprising aligning smectic liquid crystal in a homogenous horizontal alignment state, and transferring the homogenous alignment to a hybrid alignment while stabilizing the alignment by photo-crosslinking or thermal-crosslinking. This mechanism can be explained as follows:

The polymerization process may result in interlayer shrinkage between smectic layers, and the shrinkage may cause focal conic distortion so that the smectic layers are distorted and biased. As a result, a hybrid alignment state can be obtained.

According to the mechanism, the tilt angle can be adjusted to a preferred range by controlling a polymerization-shrinkage ratio and a polymerization progression ratio. A retardation layer produced by using smectic liquid crystal exhibits small scattering-polarization elimination due to fluctuation in alignment of smectic liquid crystal; and, therefore, such a retardation layer is more effective in the application that 100 nm or more retardation is required. Examples of the material or the method, which can be employed in production of the retardation layer, will be described later.

[Optical Property of Retardation Plate]

The retardation of the retardation layer may be predetermined depending on the wavelength of the color filter layer, the retardation of the liquid crystal cell at ON or OFF time, or the retardation or the angle of direction of another retardation layer (for example, an observer-side retardation layer).

A phase angle of a retardation layer is defined as a value obtained by multiplying the value, which is obtained by dividing its retardation value by a wavelength, by 2π. According to the phase angle value, it is possible to know how phase is required to compensate a viewing angle property without considering wavelength; and, thus, a phase angle of a layer is suitable for being used as an indicator showing an optical property of the layer. The phase angle of the hybrid-alignment retardation layer preferably ranges from 50° to 130°, more preferably from 600 to 125°, and much more preferably from 65° to 120° for any colors such as R, G and B of the color filter.

[Arrangement of Hybrid-Alignment Retardation layer]

In one preferred embodiment of the liquid crystal display of the invention, a mean direction of directors of liquid crystal molecules in the liquid crystal layer projected on to a layer plane is substantially parallel to a mean direction of directors of liquid crystal molecules fixed in a hybrid alignment state in the retardation layer projected on to a layer plane. It is to be noted that the term “substantially parallel” regarding to axes means that the angle between the two axes is −10° to 10°. The angle preferably ranges from −5° to 5°, and more preferably from −3° to 3°.

The directors of liquid crystal molecules in the liquid crystal call can be adjusted to a desired direction by controlling the rubbing direction of an alignment layer. When rod-like liquid crystal molecules are used for preparing the retardation layer, it is preferable that the mean tilting direction of liquid crystal molecules in the retardation layer is adjusted to a 180° direction regarding to the mean tilting direction of liquid crystal molecules in the liquid crystal cell in the black state. When discotic liquid crystal molecules are used for preparing the retardation layer, it is preferable that the mean tilting direction of liquid crystal molecules in the retardation layer is adjusted to a direction equal to the mean tilting direction of liquid crystal molecules in the liquid crystal cell in the black state.

Employing such angular relations, it is possible to reduce the retardation-dependency in an oblique direction in the black state and to improve the contrast-viewing angle property.

[Position of Hybrid-Alignment Retardation Layer]

In the invention, the hybrid-alignment retardation layer is disposed in each transmissive portion. The retardation layer disposed in each transmissive portion can contribute to reducing production cost since two retardation plates, which have been conventionally disposed between a backlight-side polarizing plate and a liquid crystal substrate, can be omitted. The retardation layer disposed in each transmissive portion can also contribute to improving brightness in a transmissive state since the light reflected by a reflecting plate can go back to a backlight unit without the absorption by a backlight-side polarizing plate and be recycled in the unit.

In the invention, the hybrid-alignment retardation layer may be disposed on either the backlight-side or the observer-side substrate of the liquid crystal layer. Since the fine areas can be created easily by dividing with a barrier wall, for the embodiment in which the hybrid-alignment retardation layer is disposed on the backlight-side substrate, the retardation layer is preferably disposed between the substrate and the transparent electrode; and, for the embodiment in which the hybrid-alignment retardation layer is disposed on the observer-side substrate, the retardation layer is preferably disposed between the substrate and the color filter or between the color filter and the transparent electrode.

[Method for Manufacturing Liquid Crystal Display]

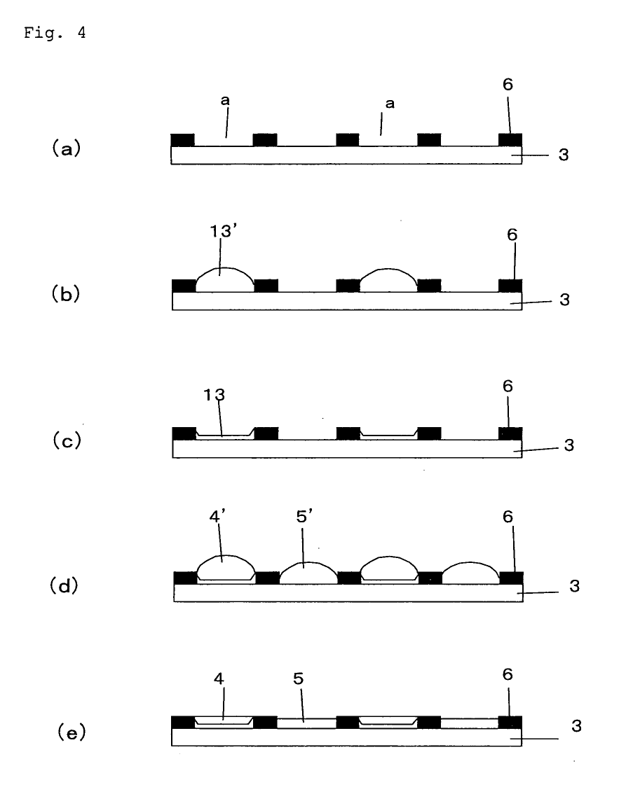

One example of the process for producing the liquid crystal display of the invention will be described while referring to FIG. 4.

On a transparent substrate 3 composed of glass etc., a black matrix 6 (barrier walls) of dot pattern is formed using a negative type black matrix resist material according to a photo lithographic method to form plural fine areas separated by the barrier walls 6 (FIG. 4(A)). Incidentally, in the formation of the black matrix 6, there is no particular limitation on the material and process for forming the black matrix, and the black matrix may be formed according to a method other than the photo lithographic method. The pattern of black matrix 6 is not limited to the dot pattern. There is no particular limitation on the alignment of a color filter to be formed, and any of dot alignment, stripe alignment, mosaic alignment and delta alignment can be used.

The black matrix 6 is preferably subjected to plasma treatment after the formation with a gas of fluorine-containing compound (such as CF₄) so that the surface thereof is treated to be ink-rejecting. The ink-rejecting black matrix 6 may be obtained according to a method other than the above-described plasma treatment. For example, the ink-rejecting black matrix can be obtained by producing the black matrix using a material comprising an ink-rejecting agent, or using an ink-rejecting material.

Next, a fluid composition 13′, e.g., a solution, which exhibits an intended optical anisotropy, is ejected by using an ink jet apparatus to the fine areas separated by the blackmatrix 6, if desired, having been subjected to the above mentioned ink-rejecting treatment, to form layers of the fluid on the fine areas (FIG. 4 (b). The fluid preferably comprises at least one type of a liquid crystalline compound and is preferably prepared so that it forms a liquid crystal phase after drying. The fluid is merely required to have sufficient properties for ejection from an ink jet apparatus, and any types of fluid may be used. Although dispersions in which a part or whole of material such as a liquid crystalline compound are dispersed may be used, solutions are preferably used. After being ejected to the fine areas, the fluid is dried to form a liquid crystal phase, and exposed to form a retardation layer 13 (FIG. 4(c)). In order to form a liquid crystal phase, if desired, it may be heated, and, in that case, any heating apparatus may be used.

To each retardation layer 13 formed in the manner described above or to each reflective portion having no retardation layer thereon, an ink fluid 4′ or 15′ is secondarily ejected (FIG. 4 (d)), dried and, if desired, exposed to form a color filter layer 4 in each transmissive portion and a color filter layer 5 in each reflective portion (FIG. 4(e)). After that, an overcoat layer capable of planarizing the surface may be formed on the color filter layer.

There is no particular limitation on the ejection condition of the fluid such as ink upon forming the retardation layer 13 and color filter layers 4 and 5, but, when a fluid for forming the retardation layer and an ink for forming the color filter layers have a high viscosity, it is preferred to eject these with a reduced viscosity under room temperature or elevated temperatures (such as 20-70° C.) in terms of ejection stability. Since the variation of viscosity of the ink etc. has directly a significant influence on the droplet size and droplet ejection rate to result in an image-quality degradation, the temperature of ink etc. is preferably kept as constant as possible.

An ink jet head (hereinafter, it may also be simply referred to as a head) for use in the process of the invention is not particularly limited, and publicly known various ones can be used. Ahead of the continuous type or dot on-demand type may be used. Among the dot on-demand type, as a thermal head, a type having such operative valve for ejection as described in JP-A-9-323420 is preferred. In the case of a piezo head, for example, heads described in EP 277,703 A, EP 278,590 A etc. can be used. A head having a temperature-controlling function is preferred so that the temperature of a composition can be regulated. It is preferred that the ejection temperature is controlled so that the viscosity at ejection becomes 5-25 mPa·s, and that the composition temperature is controlled so as to give the fluctuation range of the viscosity of ±5% or less. As to the drive frequency, operation at 1-500 kHz is preferred.

The order of the retardation layer 13 and the color filter layer 4 may be interchanged, that is, the retardation layer 13 may be formed on the color filter layer 4. The embodiment can be produced by interchanging the order of the step of forming the retardation layer 13 and the step of forming the color filter layer 4 in the above example of the producing process.

In addition, a step of preparing an alignment layer may be carried out prior to the step of preparing the retardation layer. For example, the alignment layer can be prepared by applying a fluid material containing polyvinyl alcohol, soluble polyimide or the like to a surface, drying it to form a polymer layer, and, if necessary, rubbing the surface of the polymer film. The fluid containing a liquid crystal compound for preparing the retardation layer may be ejected to the rubbed surface of the alignment layer. Photo-alignment layer, produced by irradiating with a polarized UV light or an oblique UV light, capable of giving a monoaxiality can be preferably used. The alignment layer may be prepared according to an ink-jet method or any methods other than the ink-jet method.

The retardation layer 13 may be formed by using a fluid, such as a solution, of the same type, or may be formed by using different fluids, such as solutions, containing materials different from each other and/or having different formulations (blending amounts) from each other so that each of them exhibits the optical anisotropy optimized relative to each hue of the color filter layer 4 that is formed thereon. When plural different fluids are used relative to hues of the color filter layer, the retardation layer 13 may be formed by carrying out the ejections of all of the fluids one after another, and then drying them concurrently, or by carrying out the set of the ejection of each fluid and drying it repeatedly. Similarly, the color filter layer 4 may be formed by carrying out the ejections of all of the ink fluids (e.g., ink fluids for preparing an R layer, G layer and B layer) one after another, and then drying them concurrently, or by carrying out the set of the ejection of each fluid and drying it repeatedly. In addition, the color of a color filter needs not to be limited to three colors of red (R), green (G) and blue (B). A color filter may be of multi-primary colors.

Thus, the first substrate, having thereon a retardation layer 13 and a color filter layer 4 at each fine area, corresponding each pixel, separated by black matrix 12 (barrier wall), is obtained. As mentioned above, the retardation layer 13 and the color filter layer 4 are formed by ejecting the fluid, which is prepared so as to exhibit a predetermined optical anisotropy, and the ink-fluid (e.g., red, green or blue ink fluid), and then drying them. After that, the first substrate is laminated with the second substrate. Before the lamination, a transparent electrode layer and/or an alignment layer may be formed on the color filter layer 4. For example, as described in JP-A-11-248921 and Japanese Patent No. 3255107, it is preferred, in terms of cost reduction, to form a base by superimposing colored resin compositions forming a color filter, forming a transparent electrode thereon, and, according to need, forming a spacer by superimposing protrusions for divided alignment.

A liquid crystal material may be poured into a gap between the facing surfaces of the first and second substrates to form a liquid crystal layer; and, then, a liquid crystal cell is produced. The first substrate is preferably disposed so that the surface on which the optically anisotropic layer and the color filter layer have been formed lies inside, that is, becomes a facing surface. Then, polarizing plates, optical compensatory films etc. may be laminated on the outside surfaces of both substrates, respectively, and a backlight unit may be disposed to manufacture a liquid crystal display.

According to the process mentioned above, after forming barrier walls corresponding a black matrix, the fluid for forming a retardation layer and the ink fluids for forming a color filter layer are applied to predetermined regions by using an ink jet system; and, therefore, it is possible to form accurately the optically anisotropic layer and the color filter layer in predetermined regions on the first substrate. Consequently, the desired liquid crystal cell can be obtained, without making the construction complex, with a small number of steps.

In the description of the method of the invention, an example was adopted in which the ink ejection by an ink jet method was used to form a hybrid-alignment retardation layer and color filter layers in respective fine areas. However, the liquid crystal display of the invention is not limited to the embodiment produced by such method, and, needless to say, embodiments, in which a hybrid-alignment retardation layer and/or color filter layers have been formed by utilizing a method other than the ink jet method, for example, a printing method or the like, also fall within the scope of the invention.

[Material and Process for Preparing Hybrid-Alignment Retardation Layer]

In general, liquid crystalline compounds can be classified into a rod-shaped type and a disc-shaped type on the basis of the figure thereof. Each type includes a low molecular type and a high molecular type. A high molecule generally indicates a molecule having a polymerization degree of 100 or more (Doi Masao; Polymer Physics Phase transition Dynamics, page 2 Iwanami Shoten, 1992). In the embodiment, although any types of liquid crystalline compounds can be used, the use of a rod-shaped liquid crystalline compound or a disc-shaped liquid crystalline compound is preferred. A mixture of two types or more of the rod-shaped liquid crystalline compounds, two types or more of the disc-shaped liquid crystalline compounds, or the rod-shaped liquid crystalline compound and disc-shaped liquid crystalline compound may be used. Since it is possible to make the alteration due to temperature and humidity small, a rod-shaped liquid crystalline compound or a disc-shaped liquid crystalline compound having a reactive group is preferably used for the formation. In the case of the mixture, further preferably at least one type has two or more reactive groups in one liquid crystal molecule. The liquid crystalline compound may be composed of a mixture of two types or more, and in that case, at least one type preferably has two or more reactive groups. The thickness of the retardation layer is preferably 0.1-20 μm, further preferably 0.5-10 μm.

Examples of the rod-like liquid-crystalline compound include azomethine compounds, azoxy compounds, cyanobiphenyl compounds, cyanophenyl esters, benzoate esters, cyclohexanecarboxylic acid phenyl esters, cyanophenylcyclohexane compounds, cyano-substituted phenylpyrimidine compounds, alkoxy-substituted phenylpyrimidine compounds, phenyldioxane compounds, tolan compounds and alkenylcyclohexylbenzonitrile compounds. Not only the low-molecular-weight, liquid-crystalline compound as listed in the above, high-molecular-weight, liquid-crystalline compound may also be used. High-molecular-weight liquid-crystalline compounds may be obtained by polymerizing low-molecular-weight liquid-crystalline compounds having at least one polymerizable group. Among such low-molecular-weight liquid-crystalline compounds, liquid-crystalline compounds represented by a formula (I) are preferred.
Q¹-L¹-A¹-L³-M-L⁴-A²-L²-Q² Formula (I)

In the formula, Q¹ and Q² respectively represent a polymerizable group. L¹, L², L³ and L⁴ respectively represent a single bond or a divalent linking group, and it is preferred that at least one of L³ and L⁴ represents —O—CO—O—. A¹ and A² respectively represent a C₂₋₂₀ spacer group. M represents a mesogen group.

In formula (I), Q¹ and Q² respectively represent a polymerizable group. The polymerization reaction of the polymerizable group is preferably addition polymerization (including ring opening polymerization) or condensation polymerization. In other words, the polymerizable group is preferably a functional group capable of addition polymerization reaction or condensation polymerization reaction. Examples of polymerizable groups are shown below.

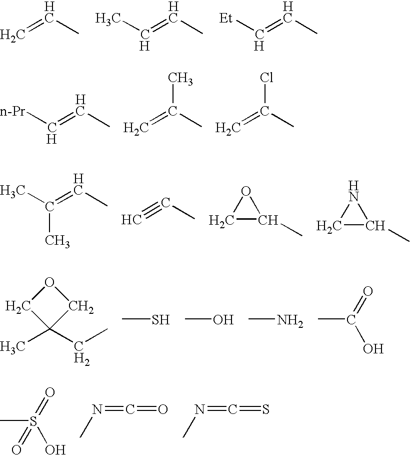

L¹, L², L³ and L⁴ independently represent a divalent linking group, and preferably represent a divalent linking group selected from the group consisting of —O—, —S—, —CO—, —NR²—, —CO—O—, —O—CO—O—, —CO—NR²—, —NR²—CO—, —O—CO—, —O—CO—NR²—, —NR²—CO—O— and —NR²—CO—NR R² represents a C₁₋₇ alkyl group or a hydrogen atom. It is preferred that at least one of L³ and L⁴ represents —O— or —O—CO—O— (carbonate group). It is preferred that Q¹-L¹ and Q²-L²- are respectively CH₂═CH—CO—O—, CH₂═C(CH₃)—CO—O— or CH₂═C(Cl)—CO—O—CO—O—; and it is more preferred they are respectively CH₂═CH—CO—O—.

In the formula, A¹ and A² preferably represent a C₂₋₂₀ spacer group. It is more preferred that they respectively represent C₂₋₁₂ aliphatic group, and much more preferred that they respectively represent a C₂₋₁₂ alkylene group. The spacer group is preferably selected from chain groups and may contain at least one unadjacent oxygen or sulfur atom. And the spacer group may have at least one substituent such as a halogen atom (fluorine, chlorine or bromine atom), cyano, methyl and ethyl.

Examples of the mesogen represented by M include any known mesogen groups. The mesogen groups represented by a formula (II) are preferred.
—(—W¹-L⁵)—W² Formula (II)

In the formula, W¹ and W² respectively represent a divalent cyclic aliphatic group, a divalent aromatic group or a divalent hetero-cyclic group; and L⁵ represents a single bond or a linking group. Examples of the linking group represented by L⁵ include those exemplified as examples of L¹ to L⁴ in the formula (I) and —CH₂—O— and —O—CH₂—. In the formula, n is 1, 2 or 3.

Examples of W¹ and W² include 1,4-cyclohexanediyl, 1,4-phenylene, pyrimidine-2,5-diyl, pyridine-2,5-diyl, 1,3,4-thiazole-2,5-diyl, 1,3,4-oxadiazole-2,5-diyl, naphtalene-2,6-diyl, naphtalene-1,5-diyl, thiophen-2,5-diyl, pyridazine-3,6-diyl. 1,4-cyclohexanediyl has two stereoisomers, cis-trans isomers, and the trans isomer is preferred. W¹ and W² may respectively have at least one substituent. Examples the substituent include a halogen atom such as a fluorine, chlorine, bromine or iodine atom; cyano; a C₁₋₁₀ alkyl group such as methyl, ethyl and propyl; a C₁₋₁₀ alkoxy group such as methoxy and ethoxy; a C₁₋₁₀ acyl group such as formyl and acetyl; a C₂₋₁₀ alkoxycarbonyl group such as methoxy carbonyl and ethoxy carbonyl; a C₂₋₁₀ acyloxy group such as acetyloxy and propionyloxy; nitro, trifluoromethyl and difluoromethyl.

Preferred examples of the basic skeleton of the mesogen group represented by the formula (II) include, but are not to be limited to, these described below. And the examples may have at least one substituent selected from the above.

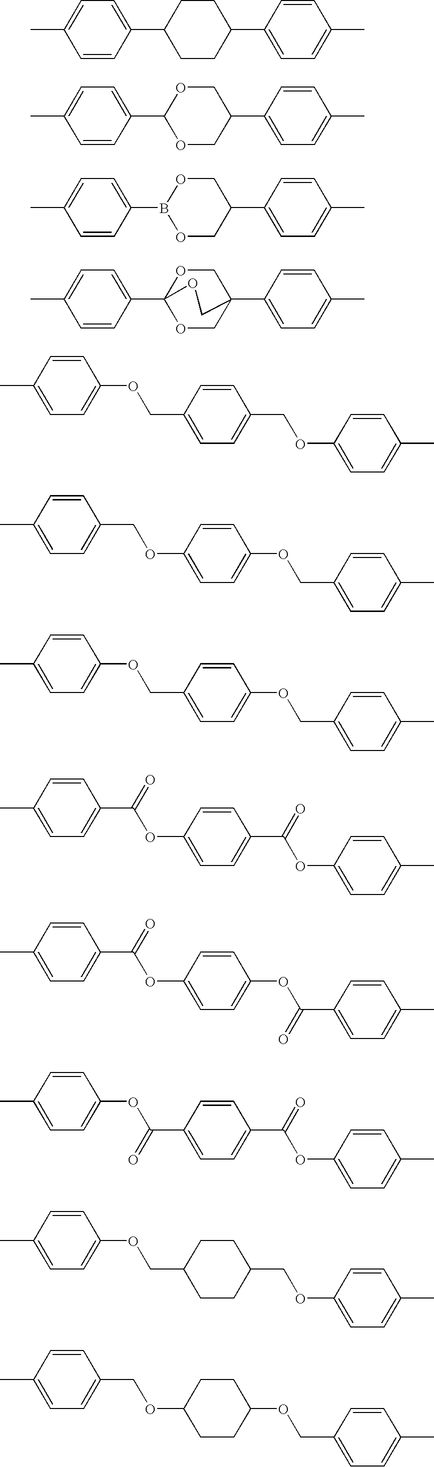

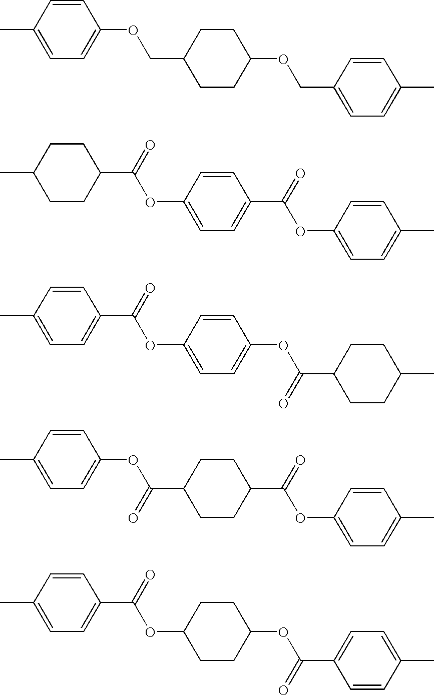

Examples the compound represented by the formula (I) include, but are not to be limited to, these described below. The compounds represented by the formula (I) may be prepared according to a method described in a gazette of Tokkohyo No. hei 11-513019.

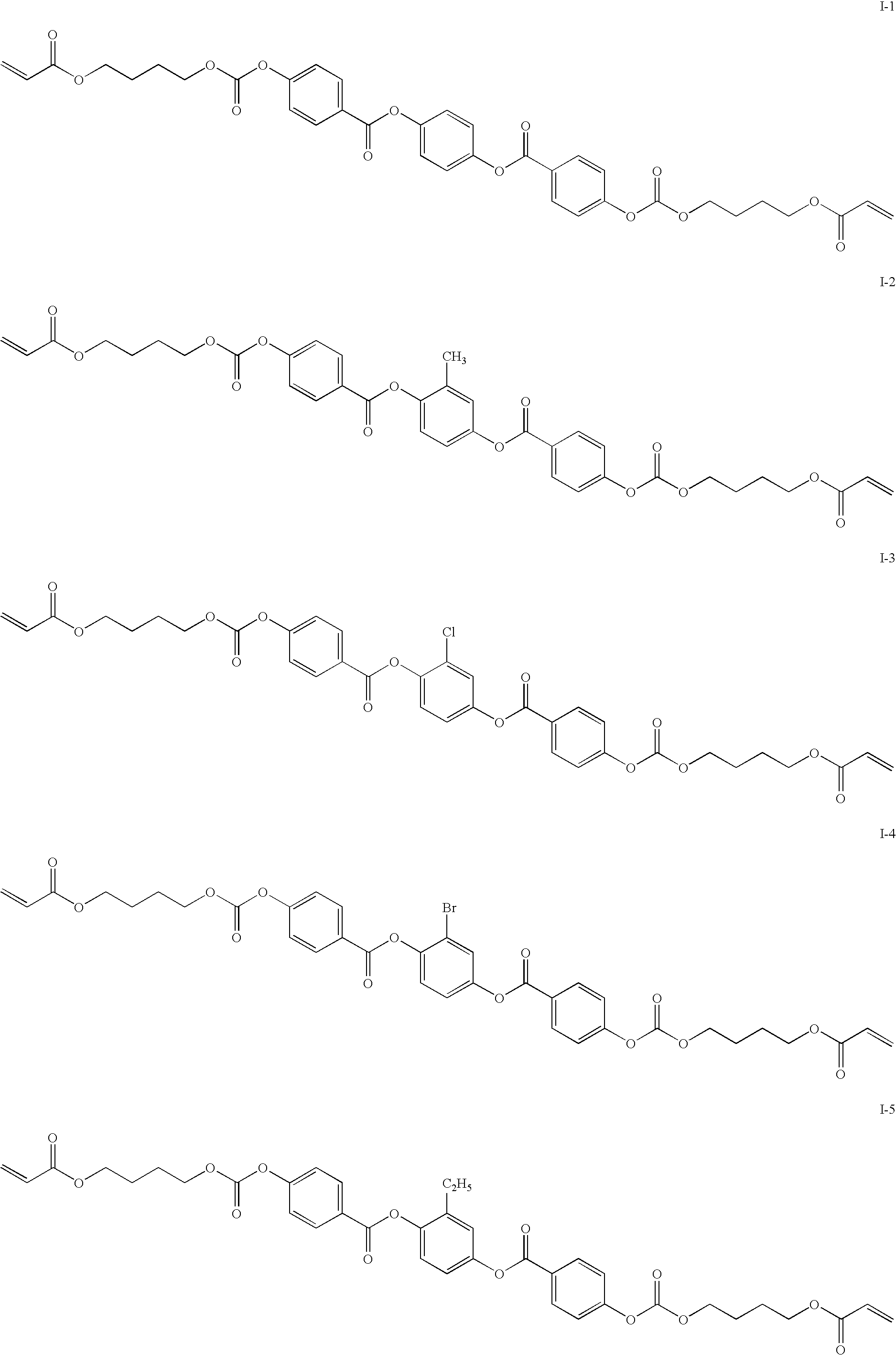

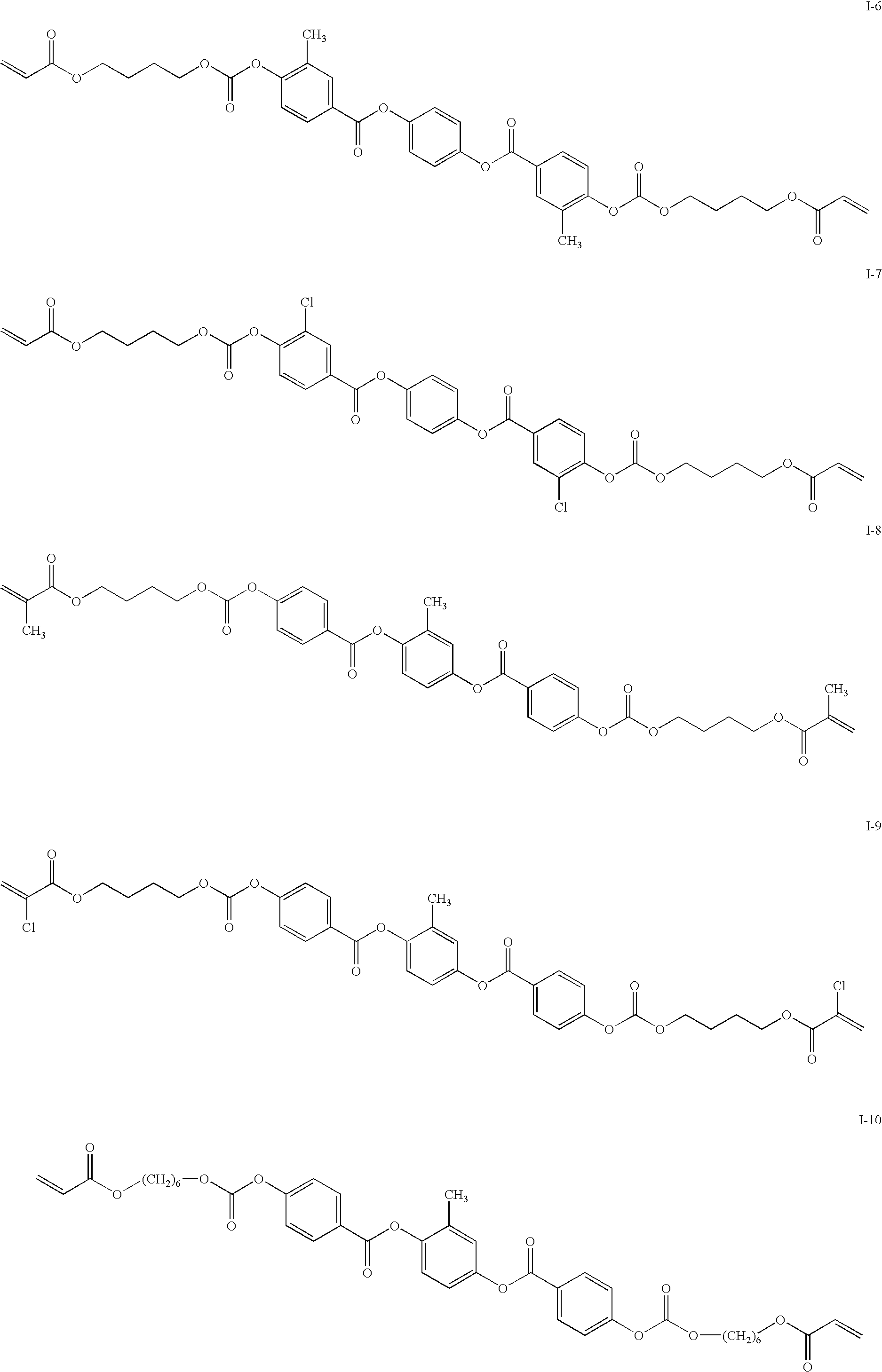

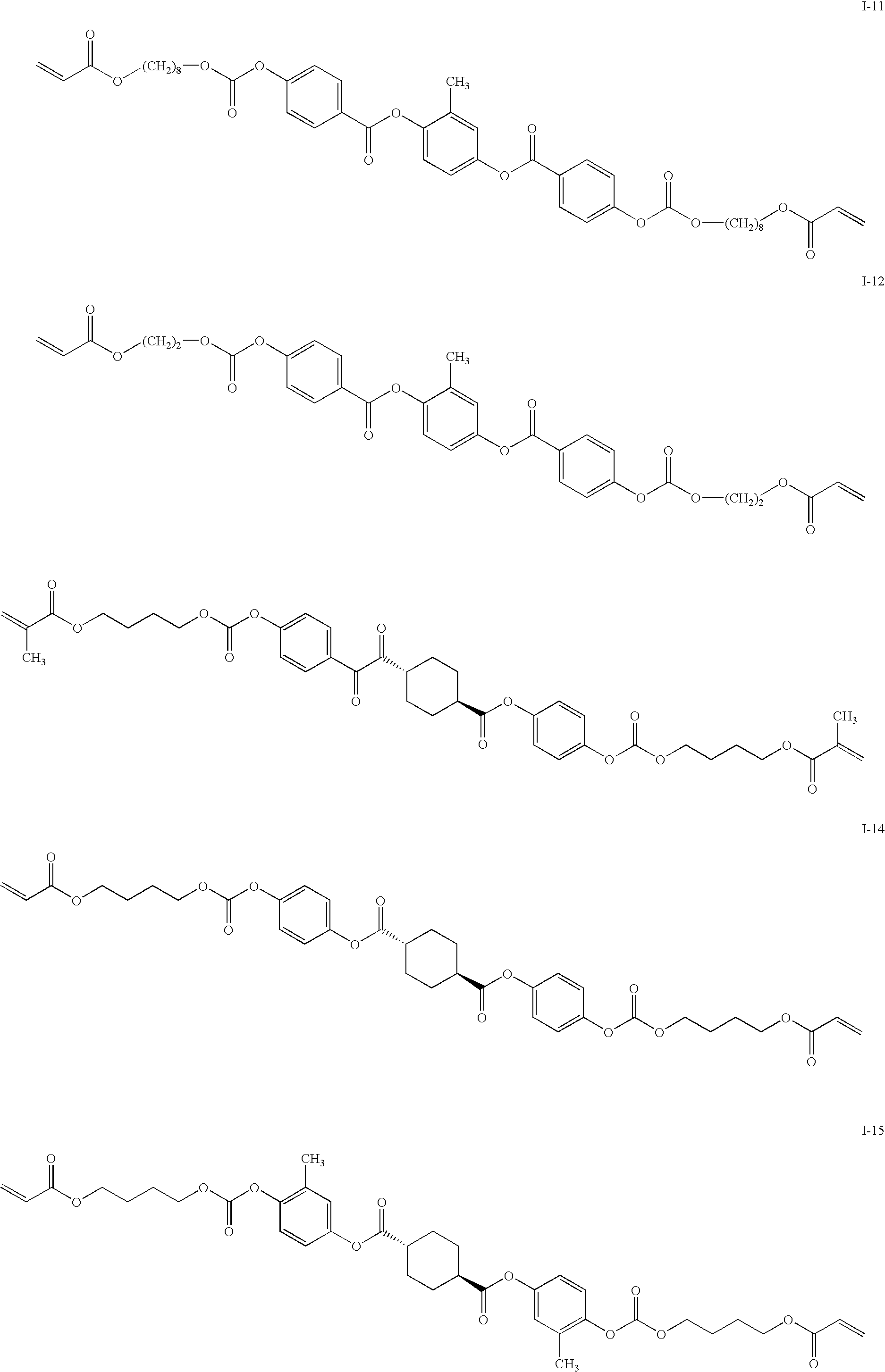

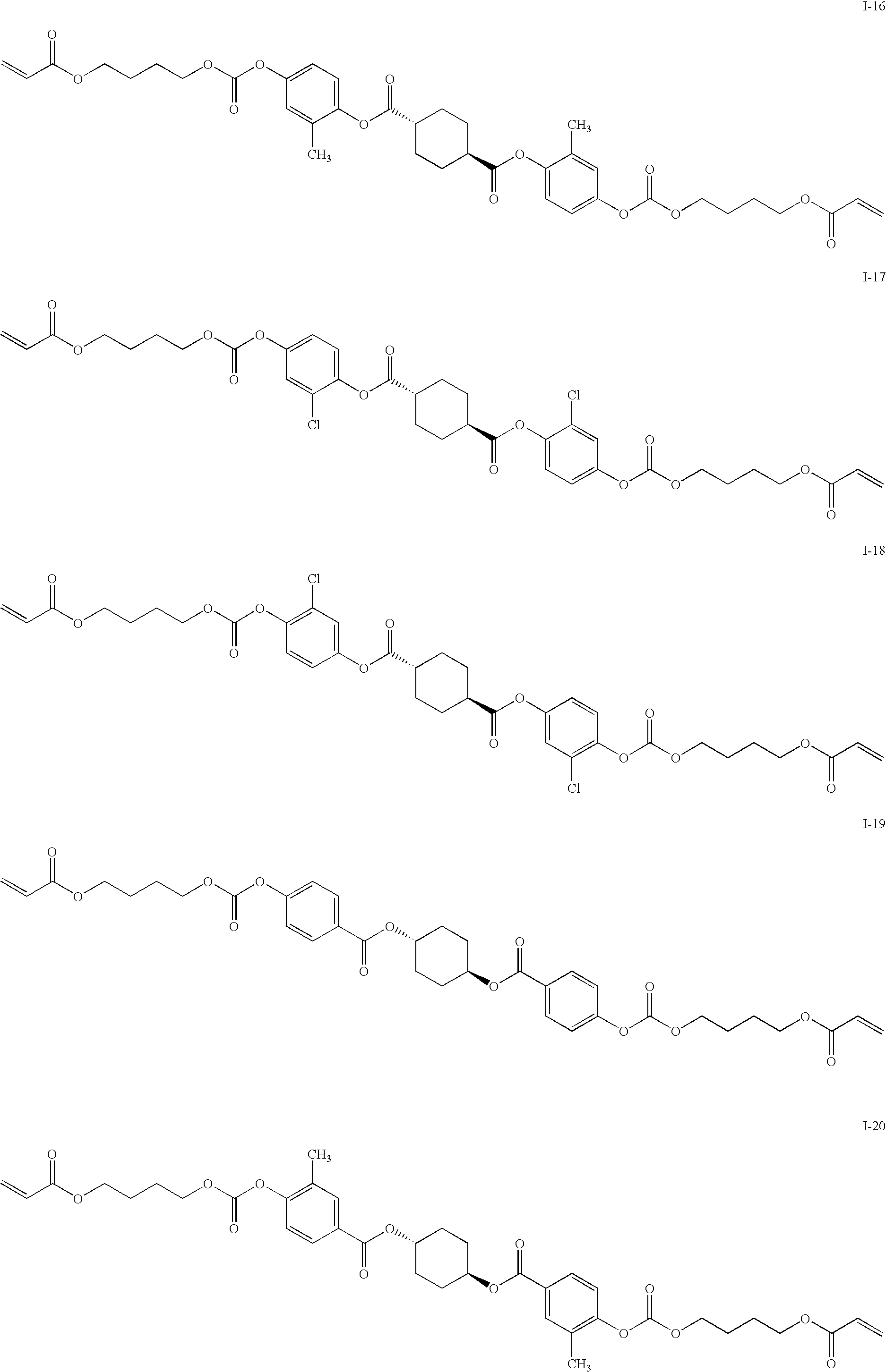

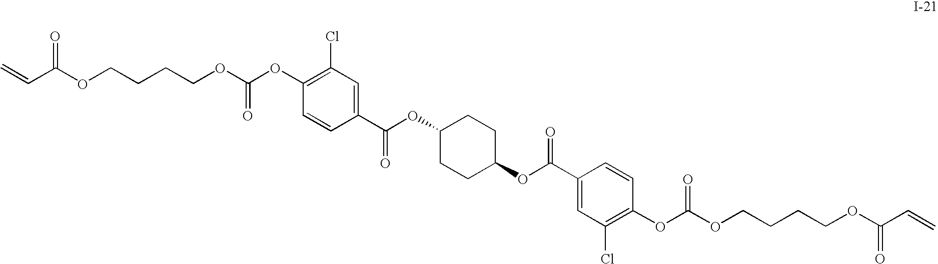

The rod-like liquid crystal compounds may be selected from any liquid crystal compounds exhibiting a smectic phase. Preferred examples of such liquid crystal compound include, but are not to be limited to, those shown below. According to a smectic liquid crystal composition, the rod-like liquid crystal molecules are aligned uniformly in a homogeneous alignment state before the polymerization of the composition is carried out, and the homogenous alignment state is changed to a hybrid alignment state in the progress of the polymerization. The mean tilt angle of the hybrid alignment state increases as the polymerization rate is higher, and, therefore, the mean tilt angle may be adjusted by controlling one or more factors such as the amount or the type of the polymerization initiator, the oxygen gas concentration in the reaction-atmosphere, or ultra-violet light intensity. In the description, the term “smectic” is used for any smectic phases such as 5 mA, SmB, 5 mC and higher order phases.

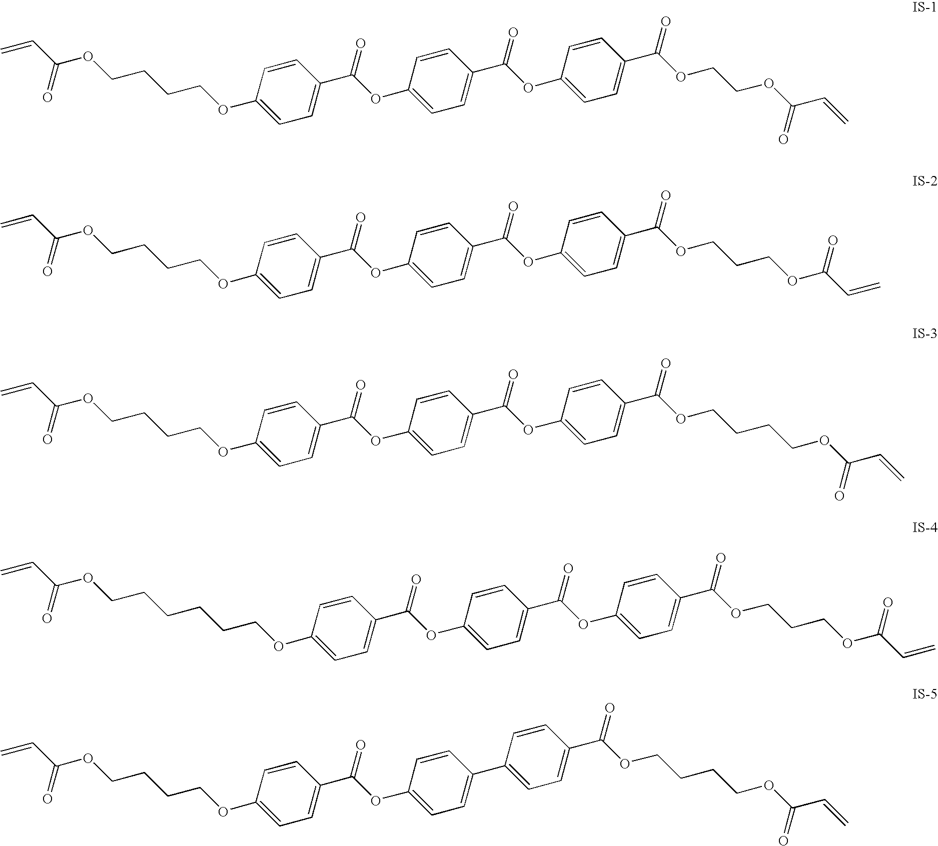

As one embodiment of the invention, there is an embodiment in which a discotic liquid crystal is used for preparing the retardation layer. The retardation layer is preferably a layer of polymer obtained by polymerization (curing) of a layer constituted of a low molecular weight liquid crystalline discotic compound such as monomer, or a polymerizable liquid crystalline discotic compound. Examples of the discotic (disc-like) compound include benzene derivatives described in a research paper of C. Destrade et al., Mol. Cryst. vol. 71, p 111 (1981), truxene derivatives described in research papers of C. Destrade et al., Mol. Cryst. vol. 122, p 141 (1985), Physicslett, A, vol. 78, p 82 (1990), cyclohexane derivatives described in a research paper of B. Kohne, et al., Angew. Chem. vol. 96, p 70 (1984), and azacrown-based and phenylacetylene-based macrocycles described in a research paper of J. M. Lehn et al., J. Chem. Commun., p 1794 (1985) and in a research paper of J. Zhang et al., J. Am. Chem. Soc. vol. 116, p 2655 (1994). The discotic (disc-like) compound generally has such construction that these molecules lie as a disk-like mother nucleus at the molecule center, to which such groups (L) as linear alkyl groups or alkoxy groups, or substituted benzoyloxy groups are substituted radially. It shows liquid crystalline properties and includes compounds generally called discotic liquid crystal. When aggregates of such molecules align evenly, a negative optically uniaxial property is shown, but the instance is not limited to this description. Further, in the invention, “it has been formed from a disk-like compound” does not necessarily mean that the finally formed compound is the aforementioned compound. For example, when the aforementioned low molecular discotic liquid crystal has a group capable of reaction by heat, light etc., a compound, which is resulted from polymerization or crosslinking through the reaction by heat, light etc. to have a high molecular weight and lose liquid crystalline property, is also included.

According to the invention, the discotic liquid-crystalline compound represented by the formula (III) shown below are preferably used.
D(-L-P)ₙ Formula (III)

In the formula, D is a discotic core; L represents a divalent liking group; P represents a polymerizable group; n is an integer ranging from 4 to 12.

Preferred examples of the discotic core (D), the divalent linking group (L) and the polymerizable group (P) are respectively (Dl) to (D15), (L1) to (L25) and (P1) to (P18) described in JPA No. 2001-4837; and the descriptions regarding the discotic core (D), the divalent linking group (L) and the polymerizable group (P) may be preferably applicable to this embodiment.

Preferred examples of the discotic compound are shown below.

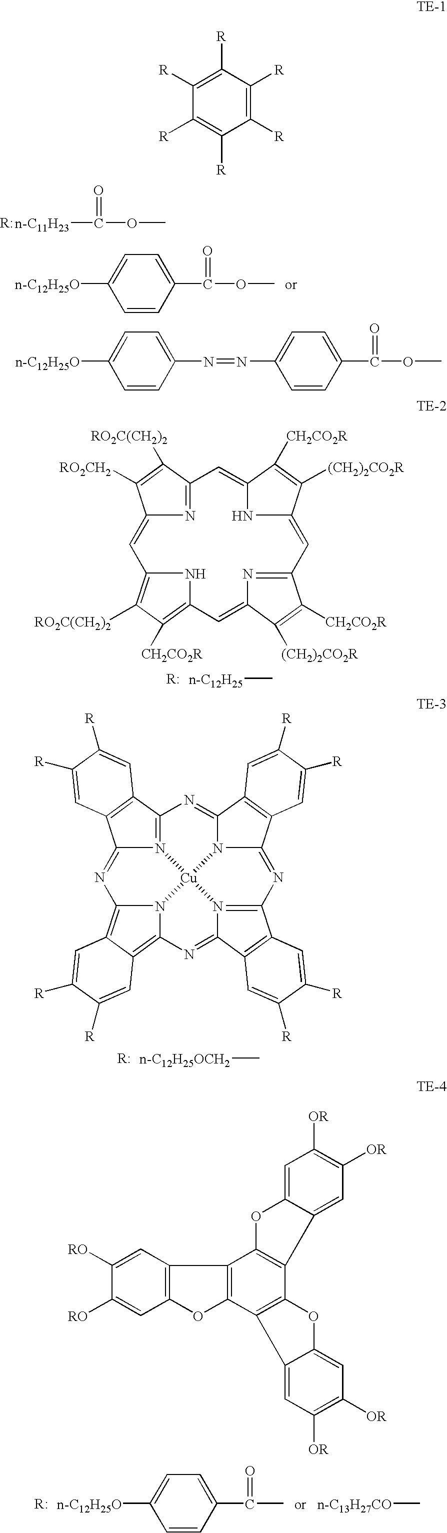

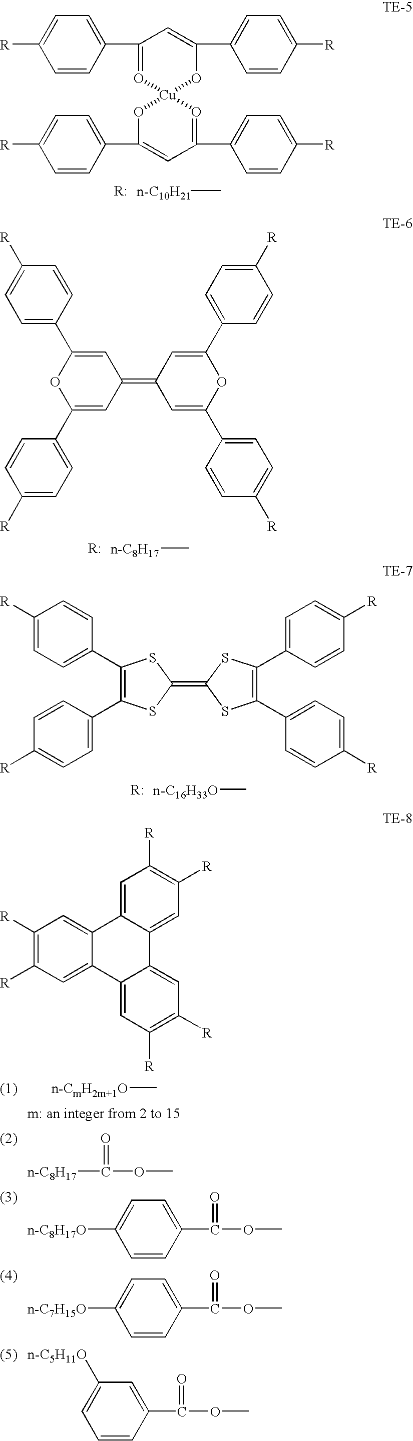

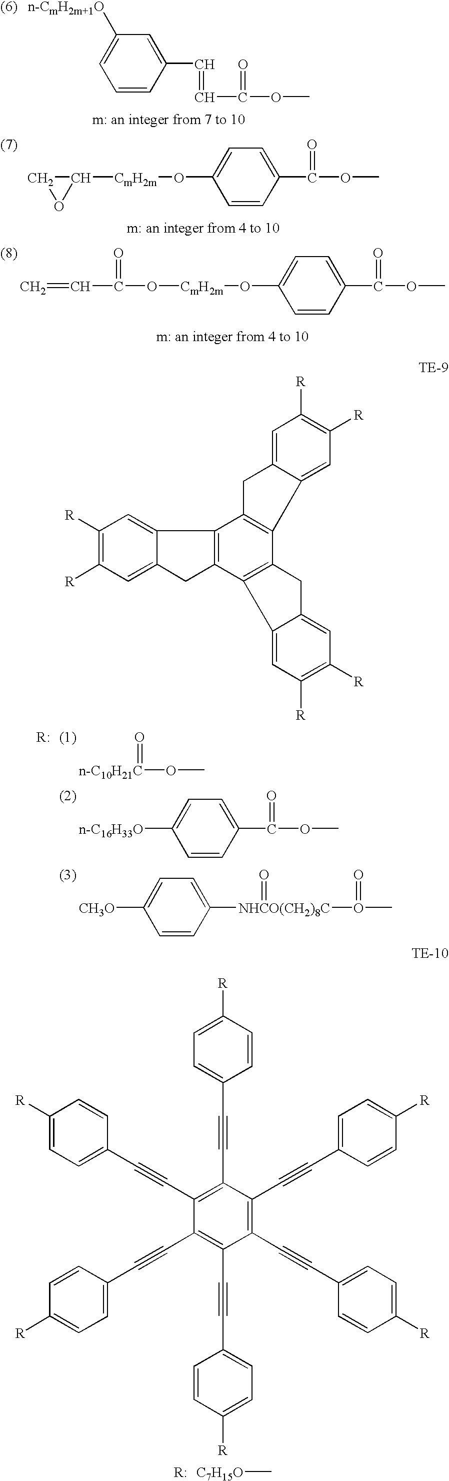

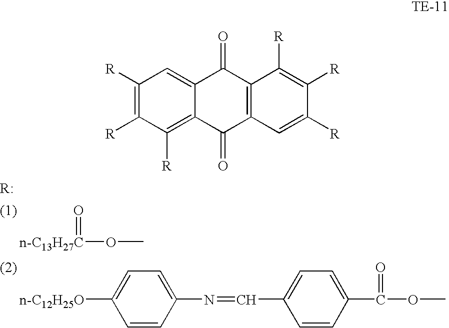

The aforementioned retardation layer is preferably a layer prepared by applying a fluid containing a liquid crystalline compound (for example, a solution of a liquid crystalline compound) to regions separated by the black matrix with an ink jet system, aligning the same in an alignment state (a hybrid alignment state), and then stabilizing the aligned state by irradiation with heat or ionizing radiation.

The retardation layer may be formed by applying a coating fluid containing a liquid crystalline compound, undermentioned polymerization initiator and other additives to a surface with an ink jet system. As the solvent for use in preparing the coating fluid, an organic solvent is preferably used. Examples of the organic solvent include amides (e.g., N,N-dimethylformamide), sulfoxides (e.g., dimethylsulfoxide), heterocyclic compounds (e.g., pyridine), hydrocarbons (e.g., benzene, hexane), alkyl halides (e.g., chloroform, dichloromethane), esters (e.g., methyl acetate, butyl acetate), ketones (e.g., acetone, methyl ethyl ketone), and ethers (e.g., tetrahydrofuran, 1,2-dimethoxyethane). Alkyl halides and ketones are preferred. Two or more types of organic solvent may be used in a mixture.

[Stabilizing Alignment State of Liquid Crystal Composition]

After being aligned in a predetermined alignment state, the liquid crystal composition is stabilized in the state. Stabilizing is preferably carried out by the polymerization reaction of the polymerizable groups contained in the liquid-crystalline molecules. The polymerization reaction includes thermal polymerization reaction using a thermal polymerization initiator and photo-polymerization reaction using a photo-polymerization initiator. Photo-polymerization reaction is preferred. Examples of photo-polymerization initiators include alpha-carbonyl compounds (described in U.S. Pat. Nos. 2,367,661 and 2,367,670), acyloin ethers (described in U.S. Pat. No. 2,448,828), alpha-hydrocarbon-substituted aromatic acyloin compounds (described in U.S. Pat. No. 2,722,512), polynuclear quinone compounds (described in U.S. Pat. Nos. 3,046,127 and 2,951,758), combinations of triarylimidazole dimers and p-aminophenyl ketone (described in U.S. Pat. No. 3,549,367), acridine and phenazine compounds (JPA No. S 60-105667 and U.S. Pat. No. 4,239,850) and oxadiazole compounds (described in U.S. Pat. No. 4,212,970).

The amount of the photo-polymerization initiators to be used is preferably 0.01 to 20% by mass, more preferably 0.5 to 5% by mass on the basis of solids in the coating liquid. Irradiation for polymerizing the liquid-crystalline molecules preferably uses UV rays. The irradiation energy is preferably 20 mJ/cm² to 10 J/cm², and more preferably 100 to 800 mJ/cm². Irradiation may be carried out in a nitrogen gas atmosphere and/or under heating to accelerate the photo-polymerization reaction.

The conversion of the polymerizable group(s) of the liquid crystal compound is desirably equal to or more than 85% m more desirably equal to or more than 90%, and much more desirably equal to or more than 95% in terms of maintenance of mechanical strength of the retardation film or prevention of the outflow of un-reacting ingredients to the liquid crystal layer. In order to improve the conversion of the polymerizable group(s), the irradiance level of ultra-visible light may be increased or the polymerization reaction may be carried out under a nitrogen atmosphere or under heating. Or, after the first polymerization reaction at a temperature is ended, a second polymerization reaction may be further carried out by applying heat so that a temperature is higher than the polymerization temperature, or applying ultra-violet light again. The conversion of the polymerizable group(s) can be measured by comparing the absorption strengths of the infrared vibration spectra which are measured before and after the polymerization.

[Adjusting Tilt Angles of Liquid Crystal Molecules]

The tilt angles at a downside interface (or in other words, a substrate-side interface) and at an upper-side interface(or in other words, an air-interface) of the hybrid-alignment retardation layer an be adjusted by selecting the types of the alignment layers and alignment aids at an air-interface to be added to the layer. Examples of the air-interface alignment aids capable of increasing or decreasing the tilt angles at the alignment-layer interface or the air-interface will be described below. The hybrid alignment of the retardation layer may be produced by adjusting the tilt angle at the air-interface so as to be bigger than the tilt angle at the alignment-layer interface. The hybrid alignment of the retardation layer may also be produced by adjusting the tilt angle at the air-interface so as to be smaller than the tilt angle at the alignment-layer interface. Both of the embodiments are preferred.

The thickness of the retardation film desirably ranges from 0.1 to 10 μm, and more desirably from 0.3 to 5 μm.

It is possible to decrease the tilt angle at the air-interface or align the liquid crystal molecules at the air-interface horizontally by adding at least one compound represented by a formula (1), (2) or (3) shown below to the composition used for forming the retardation layer. In such a case, a high-tilt alignment layer may be used, and, then, the hybrid alignment in which the tilt angle decreases along the direction going from the downside interface (the alignment-layer interface) to the upper-side interface (the air-interface). The decreasing degree of the tilt angle depends on the amount of the compound added to the composition; and, thus, the tilt angle can be adjusted to the preferred rage by controlling the amount of the compound to be added to the composition. It is to be noted that the term “horizontal alignment” means that, regarding rod-like liquid-crystalline molecules, the molecular long axes thereof and a layer plane are parallel to each other, and, regarding discotic liquid-crystalline molecules, the disk-planes of the cores thereof and a layer plane are parallel to each other. However, they are not required to be exactly parallel to each other, and, in the specification, the term “horizontal alignment” should be understood as an alignment state in which molecules are aligned with a tilt angle against a layer plane less than 10 degree.

The formula (1) to (3) will be described in detail below.

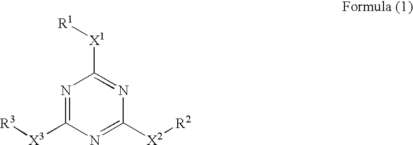

In the formula, R¹, R² and R³ respectively represent a hydrogen atom or a substituent; and X¹, X² and X³ respectively represent a single bond or a divalent linking group. Preferred examples of the substituent represented by R¹, R² or R³ include substituted or non-substituted alkyls (preferably non-substituted alkyls or fluoro-substituted alkyls), substituted or non-substituted aryls (preferably aryls having at least one non-substituted alkyl or fluoro-substituted alkyl), substituted or non-substituted aminos, substitute or non-substituted alkoxys, substituted or non-substituted alkylthios and halogens. The X¹, X² and X³ respectively represent a divalent linking group; preferably represent a divalent group selected from the group consisting of an alkylene, an alkenylene, a divalent aromatic group, a divalent cyclic group, —CO—, —NR^{a}-(R^{a} represents a C₁₋₅ alkyl or a hydrogen atom), —O—, —S—, —SO—, —SO₂— and combinations thereof; and more preferably represent a divalent linking group selected from the group consisting of an alkylene, phenylene, —CO—, —NR^{a}—, —O—, —S— and —SO₂— and any combinations thereof. The number of carbon atoms of the alkylene preferably ranges from 1 to 12. The number of carbon atoms of the alkenylene preferably ranges from 2 to 12. The number of carbon atoms of the divalent aromatic group preferably ranges from 6 to 10.

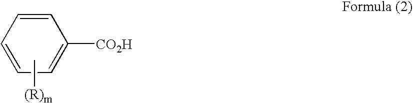

In the formula, R represents a substituent, m is an integer from 0 to 5. When m is 2 or more, plural R may be same or different each other. Preferred examples of the substituent represented by R are same as those exemplified as examples of R¹, R² or R³ in the formula (1). In the formula (2), m preferably represents an integer ranging from 1 to 3, and is more preferably 2 or 3.

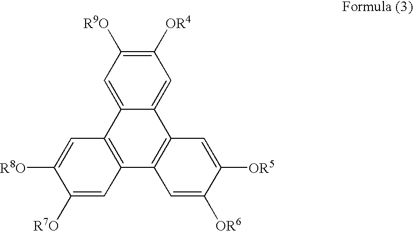

In the formula, R⁴, R⁵, R⁶, R⁷, R⁸ and R⁹ respectively represent a hydrogen atom or a substituent. Preferred examples of the substituent represented by R⁴, R⁵, R⁶, R⁷, R⁸ and R⁹ are same as those exemplified as examples of R¹, R² or R³ in the formula (1).

Examples of the planar alignment agent, which can be used in the present invention, include those described in JPA No. 2005-099258 and the methods for preparing such compounds are described in the document.

The amount of the compound represented by the formula (1), (2) or (3) is preferably from 0.01 to 20 mass %, more preferably from 0.01 to 10 mass % and much more preferably from 0.02 to 1 mass %. One type compound may be selected from the formula (1), (2) or (3) and used singly, or two or more type of compounds may be selected from the formula (1), (2) or (3) and used in combination.

It is possible to increase the tilt angle at the air-interface or align the liquid crystal molecules at the air-interface vertically by adding at least one compound having an acid group such as —COOH and —SO₃H. Examples of such compound include, but are no limited to, AE-1 to AE-4 shown below. In such a case, a low-tilt alignment layer may be used, and, then, the hybrid alignment in which the tilt angle increases along the direction going from the downside interface (the alignment-layer interface) to the upper-side interface (the air-interface). The obtained tilt angle may be increase as the compound is added to the composition in a larger amount. The preferred amount of the compound depends on the desired tilt angle; and, generally, the amount of the compound is preferably from 0.01 to 20 mass %, more preferably from 0.01 to 10 mass % and much more preferably from 0.02 to 1 mass % with respect to the amount of the liquid crystal compound to be used together.

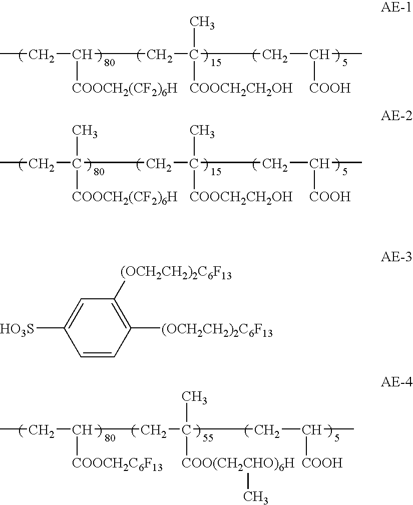

It is also possible to increase the tilt angle at the air-interface or align the liquid crystal molecules at the air-interface vertically by adding at least one ionic low-molecular compound, preferably comprising a big cation and a small anion. Examples of such compound include, but are not limited to, Compounds PE-1 to PE-6 shown below. The obtained tilt angle may be increase as the compound is added to the composition in a larger amount. The preferred amount of the compound depends on the desired tilt angle; and, generally, the amount of the compound is preferably from 0.01 to 20 mass %, more preferably from 0.01 to 10 mass % and much more preferably from 0.02 to 1 mass % with respect to the amount of the liquid crystal compound to be used together. 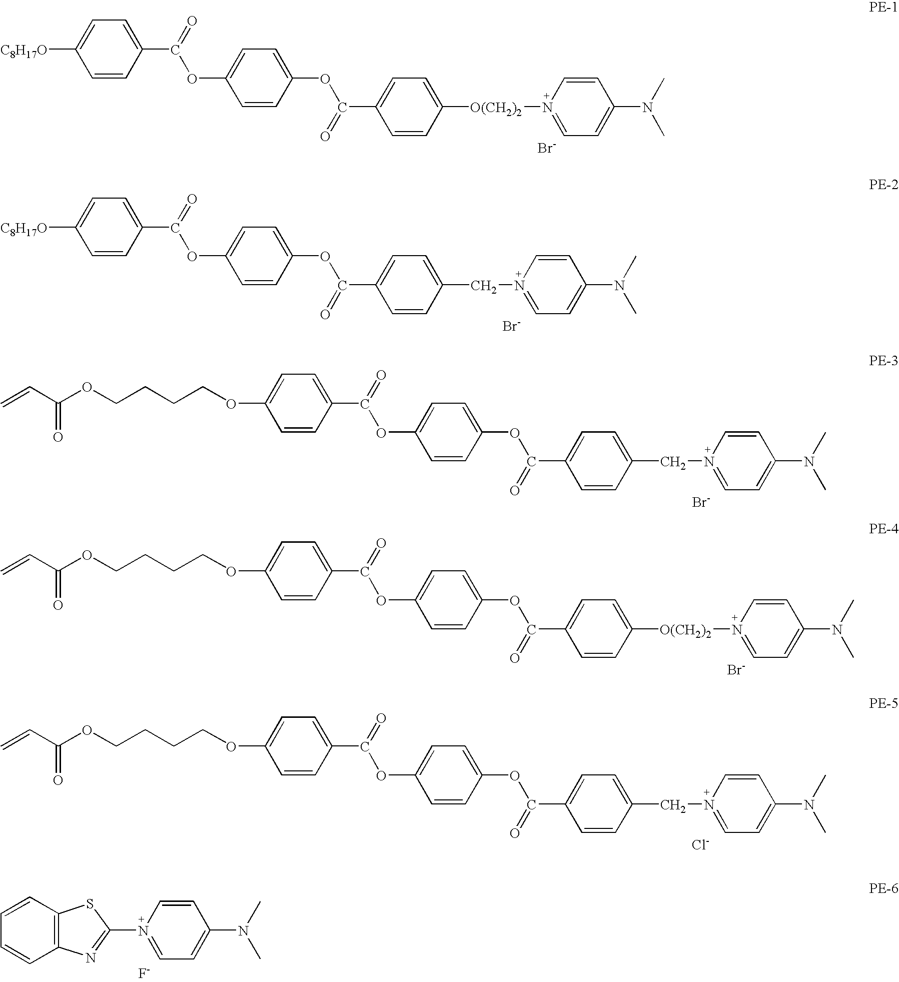
[Alignment Layer]

As described above, an alignment layer may be utilized in order to form the retardation layer. The alignment layer is generally provided on a transparent substrate or a color filter layer coated on the transparent substrate. The alignment layer functions so as to define the alignment direction of a liquid crystalline compound that is provided thereon. Any layer may be used as an alignment layer provided that it can give the alignment property to the optically anisotropic layer. Examples of the preferable alignment layer include a layer of an organic compound (preferably polymer) having been subjected to rubbing treatment, an oblique evaporation layer of an inorganic compound, a layer prepared by irradiating with a polarized light or obliquely irradiating with a natural light to a compound capable of photoisomerization and a layer having micro grooves, further, an accumulated film of Ω-tricosanoic acid, dioctadecylmethylammonium chloride or methyl stearate formed by a Langmuir-Blodgett method (LB film), and layers formed by aligning dielectric materials by applying an electric field or magnetic field.

Examples of the organic compound for the alignment layer include polymers such as polymethyl methacrylate, acrylic acid/methacrylic acid copolymer, styrene/maleinimide copolymer, polyvinyl alcohol, poly(N-methylol acrylamide), styrene/vinyl toluene copolymer, chlorosulfonated polyethylene, nitrocellulose, polyvinyl chloride, chlorinated polyolefin, polyester, polyimide, vinyl acetate/vinyl chloride copolymer, ethylene/vinyl acetate copolymer, carboxymethyl cellulose, polyethylene, polypropylene and polycarbonate, and compounds such as a silane coupling agent. Examples of preferable polymers include polyimide, polystyrene, polymers of styrene derivatives, gelatin, polyvinyl alcohol and alkyl-modified polyvinyl alcohol having an alkyl group (preferably having six or more carbon atoms).

Polymer is preferably used for forming an alignment layer. The type of polymer that is utilizable can be determined in accordance with the alignment (particularly an average tilt angle) of a liquid crystalline compound. For example, in order to align horizontally the liquid crystalline compound, a polymer that does not lower the surface energy of the alignment layer (ordinary polymer for alignment) is used. As to specific types of polymers, there are descriptions in various documents about a liquid crystal cell or an optical compensatory sheet. For example, polyvinyl alcohol or modified polyvinyl alcohol, copolymer with polyacrylic acid or polyacrylic acid ester, polyvinyl pyrrolidone, cellulose or modified cellulose are preferably used. Raw materials for the alignment layer may have a functional group capable of reacting with a reactive group of a liquid crystalline compound. The reactive group can be introduced by introducing a repeating unit having a reactive group in a side chain, or as a substituent of a cyclic group. The use of an alignment layer that forms a chemical bond with a liquid crystalline compound at the interface is more preferred. Such alignment layer is described in JPA NO. H9-152509, and modified polyvinyl alcohol to which an acrylic group is introduced in a side chain thereof using acid chloride or Karenz MOI (manufactured by SHOWA DENKO K.K.) is particularly preferred. The thickness of the alignment layer is preferably from 0.01 to 5 μm, further preferably from 0.05 to 2 μm.

In addition, a polyimide (preferably a fluorine atom-containing polyimide) film widely used as the alignment layer of LCD is also preferred as an organic alignment layer. This can be obtained by coating polyamic acid (such as LQ/LX series manufactured by Hitachi Chemical Co., Ltd., or SE series manufactured by NISSAN CHEMICAL INDUSTRIES, LTD.) on the substrate surface, burning the same at 100 to 300° C. for 0.5 to 1 hour, and then rubbing the same.

As to the rubbing treatment, a treatment method which is widely adopted as a step of aligning liquid crystal in an LCD can be utilized. That is, a method, in which the surface of the alignment layer is rubbed with paper, gauze, felt, rubber, nylon or polyester fiber in a predetermined direction to attain alignment, can be used. In general, it is practiced by carrying out the rubbing around several times using a cloth obtained by grafting uniformly fibers having a uniform length and thickness.

As a vapor deposition material for an inorganic oblique vapor deposition film, SiO is a representative example, and metal oxides such as TiO₂ and ZnO₂, fluorides such as MgF₂, and further metals such as Au and Al can be mentioned. Incidentally, any metal oxides may be used as an oblique vapor deposition material provided that it has a high permittivity, and they are not limited to those described above. An inorganic oblique vapor deposition film can be formed by using a vapor deposition apparatus. By carrying out vapor deposition while fixing a film (substrate), or carrying out vapor deposition continuously while moving a long film, an inorganic oblique vapor deposition film can be formed.

Examples of the compound capable of photoisomerization, which can be employed in preparing alignment layers according to the polarized-light irradiation method or the natural-light oblique irradiation method, include azo-type liquid crystal compounds and polymers, cinnamoyl-type compounds. Such compounds have a high sensitivity for light, and are preferred. If necessary, photosensitizer can be added to the compounds for photosensitization. Any compounds, which are capable of photoisomerization or photodimerization, and of generating anisotropy and alignment ability at the surface of the layer, can be used for preparing the alignment layers. In some embodiments, it is necessary to form the alignment layer on the substrate having a black matrix and/or a concavoconvex color filterthereon. It is difficult to form a rubbed alignment layer on such substrates, because the black matrix and the color filter may hamper the rubbing treatment. And the alignment layers prepared by irradiating with polarized or oblique light are especially useful in such embodiments.

It is possible to reduce the unevenness in optical properties of the retardation layer by adding an additive to a composition to be used for preparing the retardation layer. Such an additive can decrease surface tension of a coating fluid and improving its coating stability. the additive is preferably added to a coating fluid so that surface tension of the fluid ranges from 25 to 20 dyn/cm and preferably from 23 to 21 dyn/cm. the amount of the additive is preferably from 0.01 to 1.0 mass %, and more preferably from 0.02 to 0.5 mass %. The additive may be selected from low-molecular weight and high-molecular weight compounds. Preferable examples of the additive include fluorine-containing surfactants shown below and silicon-type compounds. The retardation layer formed of the coating fluid comprising the additive may also contribute to reducing the unevenness in displaying properties of the liquid crystal display.

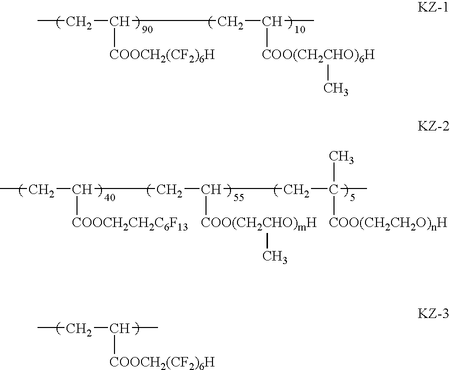

### EXAMPLES

Paragraphs below will more specifically describe the present invention referring to Examples. Any materials, reagents, amount and ratio of use and operations shown in Examples may appropriately be modified without departing from the spirit of the present invention. It is therefore understood that the present invention is by no means limited to specific Examples below.

### Example 1 to 8

(Method for Preparing Black Photosensitive Composition for Producing Barrier Wall)

A black photosensitive composition K1 was obtained by firstly weighing a K pigment dispersion 1 and propylene glycol monomethyl ether acetate in an amount listed in Table 1, which were mixed at a temperature of 24° C. (2° C.) to be stirred at 150 RPM for 10 minutes, and then weighing methyl ethyl ketone, a binder 2, hydroquinone monomethyl ether, a DPHA liquid, 2,4-bis(trichloromethyl)-6-[4′-(N,N-diethoxycarbonylmethylamino)-3′-bromophenyl]-s-triazine and a surfactant 1 in an amount listed in Table 1, which were added in this order at a temperature of 25° C. (2° C.) to be stirred at a temperature of 40° C. (2° C.) at 150 RPM for 30 minutes. Here, the amount listed in Table 1 is in part by mass, and the detailed composition is as follows.

TABLE 1

| <K Pigment Dispersion 1> | | |
|---|---|---|
| Carbon black (Nipex 35, manufactured by Degussa) | 13.1 | % |
| Dispersant (undermentioned Compound 1) | 0.65 | % |
| Polymer (random copolymer of | 6.72 | % |
| benzyl methacrylate/methacrylic acid = | | |
| 72/28 (mole ratio), molecular weight: 37000) | | |
| Propylene glycol monomethyl ether acetate | 79.53 | % |

| | |
|---|---|
| | Compound 1 |
| 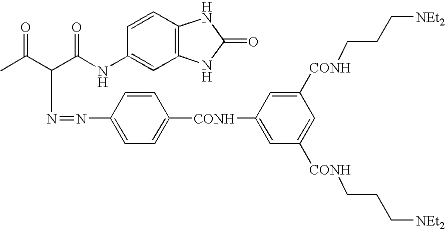 | |

| | | |
|---|---|---|
| <Binder 2> | | |
| Polymer (random copolymer of | 27 | % |
| benzyl methacrylate/methacrylic acid = | | |
| 78/22 (mole ratio), molecular weight: 38000) | | |
| Propylene glycol monomethyl ether acetate | 73 | % |
| <DPHA liquid> | | |
| Dipentaerythritol hexaacrylate (containing 500 ppm of | 76 | % |
| polymerization inhibitor MEHQ, trade name: | | |
| KAYARAD DPHA, manufactured by NIPPON | | |
| KAYAKU CO., LTD.) | | |
| Propylene glycol monomethyl ether acetate | 24 | % |
| <Surfactant 1> | | |
| Undermentioned Material 1 | 30 | % |
| Methyl ethyl ketone | 70 | % |

Material 1

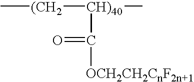

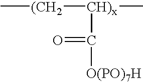

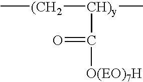

(n = 6, x = 55, y = 5, Mw = 33940, Mw/Mn = 2.55)
PO: propylene oxide
EO: ethylene oxide

| | |
|---|---|
| | (Part by mass) |
| Black photosensitive resin composition | K1 |
| K Pigment Dispersion 1 (carbon black) | 5 |
| Propylene glycol monomethyl ether acetate | 8 |
| Methyl ethyl ketone | 53 |
| Binder 2 | 9.1 |
| Hydroquinone monomethyl ether | 0.002 |
| DPHA liquid | 4.2 |
| 2,4-bis(trichloromethyl)-6-[4′-(N,N-diethoxy | 0.16 |
| carbonylmethylamino)-3′-bromophenyl]- | |
| s-triazine | |
| Surfactant 1 | 0.044 |

(Formation of Light-Shielding Barrier Wall(Black Matrix))

An alkali-free glass substrate washed with a UV washing apparatus, followed by washing with a brush using a cleaning agent, and further subjected to ultrasonic cleaning with ultrapure water. The substrate was heat-treated at 120° C. for 3 minutes to stabilize the surface state.

The substrate was cooled and controlled at 23° C., on which the black photosensitive composition K1 having the composition listed in Table 1 was coated with a coater for a glass substrate having a slit-shaped nozzle (manufactured by F. A. S.Asia, trade name: MH-1600). Therewith, it was dried in VCD (vacuum drying apparatus, manufactured by Tokyo Ohka Kogyo Co., Ltd.) for 30 seconds to dry a part of the solvent and bring about the disappearance of flowability of the coated layer, then it was pre-baked at 120° C. for 3 minutes to give a black photosensitive layer K1 having a thickness of 10 μm.

Pattern exposure was carried out with a proximity type exposing apparatus provided with an ultrahigh pressure mercury lamp (manufactured by Hitachi High-Technologies Corporation) in such state that the substrate and a mask (quartz exposure mask having an image pattern) stood vertically, while setting the distance between the exposure mask surface and the black photosensitive layer K1 to 200 μm under a nitrogen atmosphere in an exposure amount of 300 mJ/cm².

Next, pure water was sprayed with a shower nozzle to wet uniformly the surface of the black photosensitive layer K1, then shower development was effected with a KOH-based developing liquid (containing KOH, nonionic surfactant, trade name: CDK-1, manufactured by FUJIFILM ELECTRONIC MATERIALS CO., LTD.) at 23° C. for 80 seconds at a flat nozzle pressure of 0.04 MPa to give a patterned image. Therewith, ultrapure water was jetted with an ultrahigh-pressure washing nozzle at a pressure of 9.8 MPa to remove residues, which was subjected to post-exposure under room air in an exposure amount of 2000 mJ/cm² to give a black barrier wall having an optical density of 3.9. On the surface of glass substrate, fine domains separated by the black barrier wall, a black matrix, were formed. The substrate having a black matrix thereon was used as Substrate SU.

(Preparation of Coating Liquid A1 for Alignment Layer)

A commercially available poly(amic acid) solution (SE-150, manufactured by NISSAN CHEMICAL INDUSTRIES, LTD.) was diluted with N-methylpyrrolidone so that the solid concentration was 2 mass %, filtered with a polypropylene filter having a pore diameter of 30 μm, and used as a coating liquid A1 for an alignment layer.

(Preparation of Coating Liquid A2 for Alignment Layer)

The following composition was prepared, which was then filtered with a polypropylene filter having a pore diameter of 30 μm and used as a coating liquid A2 for an alignment layer.

Composition of Coating Liquid for Alignment Layer (%)

| | |
|---|---|
| Polyvinyl alcohol (PVA205, manufactured by | 3.21 |
| KURARAY CO., LTD.) | |
| Polyvinyl pyrrolidone (Luvitec K30, manufactured | 1.48 |
| by BASF) | |
| Distilled water | 52.1 |
| Methanol | 43.21 |

(Preparation of Coating Liquids LCR1 to LCR7 for Hybrid-alignment Retardation Layer)

The following compositions having a formulation, shown in the table below, respectively prepared by using a compound shown below and the exemplified compound above, were then filtered with a polypropylene filter having a pore diameter of 0.2 μm, and used as coating liquids LCR1 to LCR7 for a retardation layer respectively.

Discotic Liquid Crystal Compound

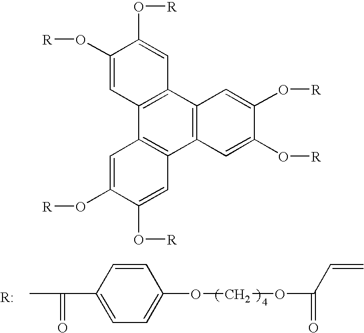

Agent for decreasing tilt angles at air-interfaces

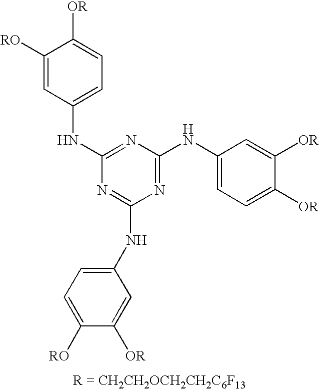

Monomer

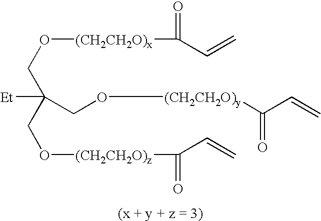

Photo-polymerization Initiator

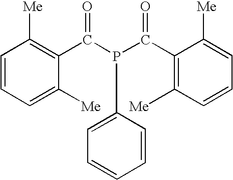

| Ingredients | LCR1 | LCR2 | LCR3 | LCR4 | LCR5 | LCR6 | LCR7 | LCR8 | LCR9 |
|---|---|---|---|---|---|---|---|---|---|
| Nematic rod-like LC I-2 | 100 | 100 | — | — | — | — | — | 100 | — |
| Smectic rod-like LC IS-5 | — | — | — | — | 100 | — | — | — | — |
| Nematic discotic LC (described | — | — | 100 | 100 | — | 100 | 100 | — | 100 |
| above) | | | | | | | | | |
| Agent for decreasing Tilt angles at | — | — | 0.4 | — | — | 0.4 | — | — | 0.4 |
| air-interfaces (described above) | | | | | | | | | |
| Agent for increasing tilt angles | — | 0.2 | — | 0.2 | 0.2 | — | 0.05 | 0.2 | — |
| at air-interfaces AE-2 | | | | | | | | | |
| Agent for decreasing tilt angles at | — | 1 | 0.02 | 0.2 | — | 0.05 | 0.2 | — | 0.2 |
| alignment-layer interfaces PE-1 | | | | | | | | | |
| Monomer (described above) | — | — | 9 | 9 | — | 9 | 9 | — | 9 |
| Polymerization initiator | 3 | 3 | 3 | 3 | 3 | 3 | 3 | 3 | 3 |
| (describe above) | | | | | | | | | |
| Solvent: methylethyl ketone | 200 | 200 | 200 | 200 | — | 200 | 200 | 200 | 200 |
| Solvent: CHCl₂ | — | — | — | — | 300 | — | — | — | — |
| Polymerization temperature | 80° C. | 80° C. | 90° C. | 90° C. | 115° C. | 90° C. | 90° C. | 80° C. | 90° C. |

Composition to be used for preparing a color filter

The formulations of the compositions to be used for preparing a Color filter are shown in Table 3.

TABLE 3

| | PP-R1 | PP-G1 | PP-B1 |
|---|---|---|---|
| R pigment dispersion-1 | 44 | — | — |
| R pigment dispersion-2 | 5.0 | — | — |
| G pigment dispersion | — | 24 | — |
| CF Yellow EC3393 | — | 13 | — |
| (from Mikuni Color Works, Ltd.) | | | |
| CF Blue EX3357 | — | — | 7.2 |
| (from Mikuni Color Works, Ltd.) | | | |
| CF Blue EX3383 | — | — | 13 |
| (from Mikuni Color Works, Ltd.) | | | |
| propylene glycol monomethyl ether | 76 | 29 | 23 |
| acetate (PGMEA) | | | |
| methyl ethyl ketone | 37.412 | 25.115 | 35.78 |
| cyclohexanone | — | 1.3 | — |
| binder 1 | — | 2.9 | — |
| binder 2 | 0.7 | — | — |
| binder 3 | — | — | 16.9 |
| DPHA solution | 4.4 | 4.3 | 3.8 |
| 2-trichloromethyl-5-(p-styrylmethyl)- | 0.14 | 0.15 | 0.15 |
| 1,3,4-oxadiazole | | | |
| 2,4-bis(trichloromethyl)-6-[4-(N,N- | 0.058 | 0.060 | — |
| diethoxycarbonylmethyl)-3- | | | |
| bromophenyl]-s-triazine | | | |
| phenothiazine | 0.010 | 0.005 | 0.020 |
| hydroquionone monomethyl ether | — | — | — |
| Hexafluoro antimonic acid triallyl | 3.37 | 2.00 | 2.00 |
| sulfonium | | | |
| HIPLAAD ED152 (from Kusumoto | 0.52 | — | — |
| Chemicals) | | | |
| Megafac F-176PF (from Dainippon Ink | 0.060 | 0.070 | 0.050 |
| and Chemicals, Inc.) | | | |

The formulations of the compositions listed in Table 3 domains follows.

[Formulation R Pigment Dispersion-1]

Formulation of R Pigment Dispersion-1 (%)

| | |
|---|---|
| C.I.Pigment Red 254 | 8.0 |
| 5-[3-oxo-2-[4-[3,5-bis(3-diethyl aminopropyl | 0.8 |
| aminocarbonyl)phenyl]aminocarbonyl]phenylazo]- | |
| butyroylaminobenzimidazolone | |
| random copolymer of benzyl methacrylate/methacrylic | 8.0 |
| acid (72/28 by molar ratio, | |
| weight-average molecular weight = 37,000) | |
| propylene glycol monomethyl ether acetate | 83.2 |

[Formulation of R Pigment Dispersion-2]

Formulation of R Pigment Dispersion-2 (%)

| | |
|---|---|
| C.I.Pigment Red 177 | 18.0 |
| random copolymer of benzyl methacrylate/methacrylic | 12.0 |
| acid (72/28 by molar ratio, | |
| weight-average molecular weigh = 37,000) | |
| propylene glycol monomethyl ether acetate | 70.0 |

[Formulation of G Pigment Dispersion]

Formulation of G Pigment Dispersion (%)

| | |
|---|---|
| C.I.Pigment Green 36 | 18.0 |
| random copolymer of benzyl methacrylate/methacrylic | 12.0 |
| acid (72/28 by molar ratio, | |
| weight-average molecular weight = 37,000) | |
| cyclohexanone | 35.0 |
| propylene glycol monomethyl ether acetate | 35.0 |

[Formulation of Binder 1]

Formulation of Binder 1 (%)

| | |
|---|---|
| random copolymer of benzyl methacrylate/methacrylic | 27.0 |
| acid (78/22 by molar ratio, | |
| weight-average molecular weight = 40,000) | |
| propylene glycol monomethyl ether acetate | 73.0 |

[Formulation of Binder 2]

Formulation of Binder 2 (%)

| | |
|---|---|
| random copolymer of benzyl methacrylate/methacrylic | 27.0 |
| acid/methyl methacrylate (38/25/37 by molar ratio, | |
| weight-average molecular weight = 30,000) | |
| propylene glycol monomethyl ether acetate | 73.0 |

[Formulation of Binder 3]

Formulation of Binder 3 (%)

| | |
|---|---|
| random copolymer of benzyl methacrylate/methacrylic | 27.0 |
| acid/methyl methacrylate(36/22/42 by molar ratio, | |
| weight-average molecular weight = 30,000) | |
| propylene glycol monomethyl ether acetate | 73.0 |

[Formulation of DPHA]

Formulation of DPHA Solution (%)

| | |
|---|---|
| KAYARAD DPHA (from Nippon Kayaku Co., Ltd.) | 76.0 |
| propylene glycol monomethyl ether acetate | 24.0 |

(Preparation of Liquid Composition PP-R1 for R Layer)

Liquid composition PP-R1 for an R layer was obtained first by weighing R pigment dispersion-1, R pigment dispersion-2 and propylene glycol monomethyl ether acetate according to the amounts listed in the Table 3 respectively, mixing them at 24° C. (±2° C.), stirring the mixture at 150 rpm for 10 minutes, weighing methyl ethyl ketone, binder 2, DPHA solution, 2-trichloromethyl-5-(p-styrylstyryl)-1,3,4-oxadiazole, 2,4-bis (trichloromethyl)-6-[4-(N,N-diethoxy carbonylmethyl)-3-bromophenyl]-s-triazine and phenothiazine according to the amounts listed in Table 3, adding them in this order at 24° C. (±2° C.), stirring the mixture at 150 rpm for 10 minutes, weighing ED152 according to the amount listed in Table 3, adding it at 24° C. (±2° C.), stirring the mixture at 150 rpm for 20 minutes, weighing Megafac F-176 PF according to the amount listed in Table 3, adding it at 24° C. (±2° C.), stirring the mixture at 30 rpm for 30 minutes, and filtering the mixture through a #200 nylon mesh.

(Preparation of Liquid Composition Pp-G1 for G Layer)

Liquid composition PP-G1 for a G layer was obtained first by first weighing G pigment dispersion, CF Yellow EX3393 and propylene glycol monomethyl ether acetate according to the amounts listed in Table 3, mixing them at 24° C. (2° C.), stirring the mixture at 150 rpm for 10 minutes, then weighing methyl ethyl ketone, cyclohexanone, binder 1, DPHA solution, 2-trichloromethyl-5-(p-styrylstyryl)-1,3,4-oxadiazole, 2,4-bis (trichloromethyl)-6-[4-(N,N-diethoxy carbonylmethyl)-3-bromophenyl]-s-triazine and phenothiazine according to the amounts listed in Table 3, adding them in this order at 24° C. (2° C.), stirring the mixture at 150 rpm for 30 minutes, then weighing Megafac F-176 PF according to the amount listed in Table 3, adding it at 24° C. (+2° C.), stirring the mixture at 30 rpm for 5 minutes, and filtering the mixture through a #200 nylon mesh.

(Preparation of Liquid Composition PP-B1 for B Layer)

Liquid composition PP-B1 for a B layer was obtained first by weighing CF Blue EX3357, CF Blue EX3383 and propylene glycol monomethyl ether acetate according to the amounts listed in Table 3, mixing them at 24° C. (±2° C.), stirring the mixture at 150 rpm for 10 minutes, then weighing methyl ethyl ketone, binder 3, DPHA solution, 2-trichloromethyl-5-(p-styrylstyryl)-1,3,4-oxadiazole, and phenothiazine according to the amounts listed in Table 3, adding them in this order at 25° C. (±2° C.), stirring the mixture at 40° C. (±2° C.) at 150 rpm for 30 minutes, then weighing Megafac F-176 PF according to the amount listed in Table 1, adding it at 24° C. (±2° C.), stirring the mixture at 30 rpm for 5 minutes, and filtering the mixture through a #200 nylon mesh.

(Production of Alignment Layer)

Substrates, having TFT (backlight side TFT), reflection electrodes, and transmissive portions thereon were prepared.

For one of the substrates, droplets of the coating liquid A1 for an alignment layer obtained above were ejected into concave portions, corresponding to the transmissive portions, of the substrate using a head of piezo system, then dried and heated at 100° C. for a minute. The obtained substrate was used as Substrate S1.

For three of the substrates, droplets of the coating liquid A2 for an alignment layer obtained above were ejected into concave portions, corresponding to the transmissive portions, of the three substrates respectively, using a head of piezo system, then dried and heated at 250° C. for 60 minutes. The obtained three substrates were used as Substrate S2 to S4 respectively.

For one Substrate SU having a black matrix thereon, prepared according to the above mentioned method, droplets of the coating liquid A1 for an alignment layer obtained above were ejected into concave portions, corresponding to the transmissive portions, of Substrate SU using a head of piezo system, then dried and heated at 100° C. for a minute. The obtained substrate was used as Substrate S5.

For other three Substrates SU having a black matrix thereon, prepared according to the above mentioned method, droplets of the coating liquid A2 for an alignment layer obtained above were ejected into concave portions, corresponding to the transmissive portions, of the three substrates respectively, using a head of piezo system, then dried and heated at 250° C. for 60 minutes. The obtained three substrates were used as Substrate S6 to S8 respectively.

The thicknesses of the formed alignment layers were 0.1 μm.

Each of the alignment layers was subjected to a rubbing treatment.

(Production of Retardation Layer)

Each of the coating liquids, LCR1 to LCR7, was ejected into concave portions having the alignment layer of a substrate, shown in Table 4, using a head of piezo system. After being dried, each coating layer was heated at a temperature, which was higher by 20° C. than the polymerization temperature shown in Table 2, for two minutes, for aging, and was developed a uniform liquid crystal phase. After the temperature was lowered to the polymerization temperature shown in Table 2; the layer was irradiated with UV (illuminance 200 mW/cm², irradiance level: 800 mJ/cm²) from a ultrahigh pressure mercury lamp under a nitrogen atmosphere of an oxygen concentration of 0.3% or less to stabilize the hybrid alignment, thereby forming a retardation layer.

The phase angle was adjusted to the range respectively corresponding to the R, G or B pixel by controlling the ejecting amount of each coating liquid, and, then, the thickness of the obtained hybrid-alignment retardation layer. The thicknesses of the retardation layers, formed on the substrates, corresponding to the R, G or B pixel were shown in Table 4. It is to be noted that Substrate SB provided with TFT disposed at a backlight side and Substrate SU disposed at an observer side, shown in Table 4, had no alignment layers.

A retardation film was prepared by using each of the coating liquids with the condition same as the mentioned above; and, then the conversion of the polymerizable group(s) of each of the liquid crystal compound(s) was measured. It was found that, regarding to the retardation films prepared by using rod-like liquid crystal compound, the conversions were 99%; and that, regarding to the retardation films prepared by using discotic liquid crystal compound, the conversions were 93%.

(Measurement of Retardation)

By a parallel nicol method employing a microscopic spectrometer, the front retardation Re(0) and retardations Re(40) and Re(−40), which are defined as retardations when an sample is inclined in ±40 degrees, respectively, while taking the slow phase axis as a rotation axis, at an arbitrary wavelength λ corresponding R, G and B respectively were measured. The tilt angles at the air-interface and the alignment-layer interface and the mean tilt angle of the retardation layer were calculated after the film was employed in a liquid crystal display panel. The obtained retardation values and the obtained phase angles of the retardation layers at wavelength corresponding R, G and B were shown in Table 4.

TABLE 4

| | | Example 1 | Example 2 | Example 3 | Example 4 |
|---|---|---|---|---|---|
| Cell | Cell construction | | | | |
| construction | Observer side polarizing plate | SU | SU | SU | SU |
| | Backlight side polarizing plate | S1 | S2 | S3 | S4 |
| Hybrid- | Coating fluid for Alignment layer | A1 | A2 | A2 | A2 |
| alignment | Coating fluid for Retardation layer | LCR1 | LCR2 | LCR3 | LCR4 |
| retardation | Thickness of Retardation layer (B)/μm | 1.38 | 1.36 | 2.58 | 3.21 |
| layer: | Thickness of Retardation layer (G)/μm | 1.88 | 1.86 | 3.64 | 4.53 |
| Production | Thickness of Retardation layer (R)/μm | 2.31 | 2.28 | 4.71 | 5.86 |
| conditions | Pretilt angle of Retardation layer at | 70 | 0 | 90 | 0 |
| and | LC layer side/° | | | | |
| Evaluation | Pretilt angle of Retardation layer at | 2 | 70 | 20 | 88 |
| results | substrate side/° | | | | |
| | Mean tilt angle/° | 36 | 35 | 55 | 44 |
| | Phase angle difference of Retardation | 75 | 75 | 107 | 107 |
| | layer (450 nm)/° | | | | |
| | Phase angle difference of Retardation | 75 | 75 | 107 | 107 |
| | layer (550 nm)/° | | | | |
| | Phase angle difference of Retardation | 75 | 75 | 107 | 107 |
| | layer (650 nm)/° | | | | |
| | Re(450 nm) of Retardation layer/nm | 93 | 93 | 134 | 134 |
| | Re(550 nm) of Retardation layer/nm | 114 | 114 | 164 | 164 |
| | Re(650 nm) of Retardation layer/nm | 135 | 135 | 194 | 194 |
| Optical | Azimuthal angle of absorption axis of | 151 | 151 | 151 | 151 |
| arrangement | observer side Polarizing plate/° | | | | |
| conditions | Re of observer side First Retardation | 250 | 250 | 250 | 250 |
| of LCD | plate/nm | | | | |
| | Azimuthal angle of Observer side First | 347 | 347 | 347 | 347 |
| | Retardation plate/nm | | | | |
| | Re of Observer side Second Retardation | 97 | 97 | 97 | 97 |
| | plate/nm | | | | |
| | Azimuthal angle of Observer side Second | 49 | 49 | 49 | 49 |
| | Retardation plate/nm | | | | |
| | Azimuthal angle of director of | 225 | 225 | 45 | 45 |
| | Retardation layer/° | | | | |
| | Alignment direction of LC layer/° | 45 | 45 | 45 | 45 |
| | Azimuthal angle of absorption axis of | 0 | 0 | 90 | 90 |
| | Backlight side Polarizing plate/° | | | | |
| Evaluation | Mean contrast | 147 | 124 | 141 | 161 |
| results | Number of gray-scale inversion points | 9 | 5 | 4 | 4 |
| | | Example 5 | Example 6 | Example 7 | Example 8 |
| Cell | Cell construction | | | | |
| construction | Observer side polarizing plate | S5 | S6 | S7 | S8 |
| | Backlight side polarizing plate | SB | SB | SB | SB |
| Hybrid- | Coating fluid for Alignment layer | A1 | A2 | A2 | A2 |
| alignment | Coating fluid for Retardation layer | LCR5 | LCR2 | LCR6 | LCR7 |
| retardation | Thickness of Retardation layer (B)/μm | 1.11 | 1.37 | 1.81 | 2.58 |
| layer: | Thickness of Retardation layer (G)/μm | 1.51 | 1.87 | 2.55 | 3.64 |
| Production | Thickness of Retardation layer (R)/μm | 1.85 | 2.29 | 3.3 | 4.71 |
| conditions | Pretilt angle of Retardation layer at | 50 | 0 | 90 | 20 |
| and | LC layer side/° | | | | |
| Evaluation | Pretilt angle of Retardation layer at | 2 | 7 | 60 | 88 |
| results | substrate side/° | | | | |
| | Mean tilt angle/° | 26 | 35 | 75 | 54 |
| | Phase angle difference of Retardation | 75 | 75 | 107 | 107 |
| | layer (450 nm)/° | | | | |
| | Phase angle difference of Retardation | 75 | 75 | 107 | 107 |
| | layer (550 nm)/° | | | | |
| | Phase angle difference of Retardation | 75 | 75 | 107 | 107 |
| | layer (650 nm)/° | | | | |
| | Re(450 nm) of Retardation layer/nm | 93 | 93 | 134 | 134 |
| | Re(550 nm) of Retardation layer/nm | 114 | 114 | 164 | 164 |
| | Re(650 nm) of Retardation layer/nm | 135 | 135 | 194 | 194 |
| Optical | Azimuthal angle of absorption axis of | 151 | 151 | 151 | 151 |
| arrangement | observer side Polarizing plate/° | | | | |
| conditions | Re of observer side First Retardation | 250 | 250 | 250 | 250 |
| of LCD | plate/nm | | | | |
| | Azimuthal angle of Observer side First | 347 | 347 | 347 | 347 |
| | Retardation plate/nm | | | | |
| | Re of Observer side Second Retardation | 97 | 97 | 97 | 97 |
| | plate/nm | | | | |
| | Azimuthal angle of Observer side Second | 49 | 49 | 49 | 49 |
| | Retardation plate/nm | | | | |
| | Azimuthal angle of director of | 225 | 225 | 45 | 45 |
| | Retardation layer/° | | | | |
| | Alignment direction of LC layer/° | 45 | 45 | 45 | 45 |
| | Azimuthal angle of absorption axis of | 0 | 0 | 90 | 90 |
| | Backlight side Polarizing plate/° | | | | |
| Evaluation | Mean contrast | 166 | 150 | 117 | 174 |
| results | Number of gray-scale inversion points | 8 | 12 | 2 | 7 |

(Production of Color Filter Layer)

Droplets of liquids for forming R, G and B layers, PP-R1, PP-G1 and PP-B1 respectively obtained above were ejected as mentioned below into concave portions corresponding to the transmissive portions, surrounded by the light-shielding barrier wall, of one of the observer side substrate SU and Substrate Nos. S5 to S8, using a head of piezo system.

The head had 318 nozzles in a nozzle density of 150 per 25.4 mm. Two of the head were fixed while dislocating respective positions in ½ of the nozzle distance in the nozzle line direction, which allowed droplets to be ejected in 300 per 25.4 mm onto the substrate in the nozzle arrangement direction. The head and ink were controlled so that the temperature near the ejecting portion was 40±0.5° C. by circulating warm water into the head.

The ink ejection from the head was controlled by the piezo driving signal given to the head making it possible to eject 6-42 μl per one droplet. In this Example, droplets were ejected from the head while transferring the glass substrate lying at a position of 1 mm below the head. The transfer speed could be set in a range of 50-200 mm/s. In addition, the piezo drive frequency was possible up to 4.6 KHz, and, by setting these, the amount of ejected droplets could be controlled.

In this Example, respective liquids for forming R, G and B layers, PP-R1, PP-G1 and PP-B1 were ejected into concave portions corresponding to intended R, G and B so that coating amount of respective pigments, R, G and B were 1.1, 1.8, 0.75 g/m² in portions corresponding to respective pixels of R, G, B, by controlling the transfer speed and drive frequency.

After that, it was dried at 100° C., and further subjected to thermal treatment at 240° C. for 1 hour to form color filter pixels on the optically anisotropic layer.

A color filter layer was formed on the reflective area of each substrate in the same manner as the production of the color filter on the transmissive portions, except that the ejection amounts of PP-R1, PP-G1 and PP-B1 were reduced to half.

An overcoat layer was formed and stabilized by sintering so that the surface was planarized.

(Formation of Transparent Electrode)

On the color filter produced above, a transparent electrode film (film thickness: 2000 Å) was formed by sputtering of ITO.

(Production of Liquid Crystal Display)

Additionally, an alignment film of polyimide was provided thereon and was subjected to an anti-parallel rubbing treatment. Next, glass beads having a particulate diameter of 4.1 μm were spread. Further, a sealing agent of epoxy resin containing spacer particles was printed onto the position corresponding to the outer frame of the black matrix provided around the pixel group of the color filter, and the color filter plate was adhered with a backlight-side substrate in each combination shown in Table 4 at a pressure of 10 kg/cm. Then, the adhered glass substrates were heat-treated at 150° C. for 90 minutes to cure the sealing agent, thereby giving a laminate of two glass substrates. The glass substrate laminate was degassed under vacuum. Then, the pressure was returned to atmospheric pressure, and liquid crystal, having a dielectric constant of +10 and Δn of 0.086, was injected into the gap between the two glass substrates to give an ECB-mode liquid crystal cell.

On an observer-side surface of the liquid crystal cell, two polycarbonate films, having retardation of 250 nm and 97 nm respectively, and a polarizing plate HLC2-2518 manufactured by SANRITZ CORPORATION were adhered with optical axis angles shown in Table 4. On a backlight-side surface of the liquid crystal cell, a polarizing plate HLC2-2518 manufactured by SANRITZ CORPORATION was adhered with optical axis angles shown in Table 4.

The direction of the director corresponding to the rubbing axis of the liquid crystal layer projected on the substrate-surface of each hybrid-alignment retardation layer was also shown in Table 4.

As a cold-cathode tube backlight for a color liquid crystal display, a three-wavelength fluorescent lamp for white light having an arbitrary hue was produced by using a fluorescent material composed of a mixture of BaMg₂Al₁₆O₂₇:Eu,Mn and LaPO₄:Ce,Tb at a mass ratio of 50:50 for green (G), Y₂O₃:Eu for red (R), and BaMgAl₁₀O₁₇:Eu for blue (B). On the backlight, the liquid crystal cell provided with the polarizing plate was disposed to produce an ECB-mode transreflective LCD.

[Evaluation]

(Evaluation of Viewing Angle)

Each LCD was placed in a dark room, and the transmission brightness values of the LCD were measured using a spectral radiometer. More specifically, the LCD was placed horizontally, and was observed while the viewing polar angle was fixed by a 10° step rotation from 0° to 800 with respect to the normal direction of the LCD; and, in each of the fixed polar angles, the viewing azimuthal angle is varied by a 100 step. The transmission brightness values at ON and OFF times were measured at each of the angles. The contrast ratio at each angle was calculated as an obtained brightness at ON time to an obtained brightness at OFF time. All of the obtained contrast ratios at any polar angle and any azimuthal angle were summed, and the sum was divided by 281 which was the total number of the measurement points. The obtained value for each LCD was shown in Table 4. The larger value means that the LCD had a wider viewing angle and a higher contrast ratio.

The measurement points in which the gray scale inversion was observed were counted, and the total number was shown in Table 4. The smaller value means that the LCD has a better viewing angle property.

The brightness values in the normal direction of all LCDs, Example 1 to 8, in a white state were 157 cd/m².

### Comparative Example Nos. 1 to 5

For Comparative Example Nos. 1 to 5, retardation layers, color filter layers and liquid crystal display were produced in the same manner as Examples, except that, for Comparative Example 1, a wide-range λ/4 consisting of two stretched films was used in the place of the hybrid-alignment retardation layer disposed between a backlight-side polarizing plate and the substrate of the liquid crystal cell.

The coating liquids, LCR8 and LCR9, shown in Table 2, comprising a rod-like liquid crystal and a discotic liquid crystal respectively, are not capable of forming a hybrid alignment layer, since the rod-like liquid crystal or the discotic liquid crystal was aligned uniformly in the layer. The LCDs of Comparative Examples were same as those of Examples in terms of the retardation values and the relationships among the projected directors of the retardation layers employed therein, except that the retardation layers employed in the LCDs of Comparative Examples were other than a hybrid-alignment retardation layer.

Each LCD was evaluated in the same manner as mentioned above, and the results and the construction of each LCD were shown in Table 5. The brightness value in the normal direction of the LCD of Comparative Example No. 1 in a white state was 119 cd/m², and the brightness values in the normal direction of all LCDs of Comparative Example Nos. 2 to 5 were 157 cd/m².

TABLE 5

| | | Comparative Example No. | | | | |
|---|---|---|---|---|---|---|
| | | 1 | 2 | 3 | 4 | 5 |
| Cell | Cell construction | | | | | |
| construction | Observer side polarizing plate | SU | SU | SU | S12 | S13 |
| | Backlight side polarizing plate | SB | S10 | S11 | SB | SB |
| Hybrid- | Coating fluid for Alignment layer | — | A1 | A2 | A1 | A2 |
| alignment | Coating fluid for Retardation layer | — | LCR8 | LCR9 | LCR8 | LCR9 |
| retardation | Thickness of Retardation layer (B)/μm | — | 0.84 | 1.66 | 0.84 | 1.66 |
| layer: | Thickness of Retardation layer (G)/μm | — | 1.14 | 2.34 | 1.14 | 2.34 |
| Production | Thickness of Retardation layer (R)/μm | — | 1.4 | 3.03 | 1.4 | 3.03 |
| conditions | Pretilt angle of Retardation layer at | — | 0 | 90 | 0 | 90 |
| and | LC layer side/° | | | | | |
| Evaluation | Pretilt angle of Retardation layer at | — | 2 | 90 | 2 | 90 |
| results | substrate side/° | | | | | |
| | Mean tilt angle/° | — | 1 | 90 | 1 | 90 |
| | Phase angle difference of Retardation | — | 75 | 107 | 75 | 107 |
| | layer (450 nm)/° | | | | | |
| | Phase angle difference of Retardation | — | 75 | 107 | 75 | 107 |
| | layer (550 nm)/° | | | | | |
| | Phase angle difference of Retardation | — | 75 | 107 | 75 | 107 |
| | layer (650 nm)/° | | | | | |
| | Re(450 nm) of Retardation layer/nm | — | 93 | 134 | 93 | 134 |
| | Re(550 nm) of Retardation layer/nm | — | 114 | 164 | 114 | 164 |
| | Re(650 nm) of Retardation layer/nm | — | 135 | 194 | 135 | 194 |
| Optical | Azimuthal angle of absorption axis of | 151 | 151 | 151 | 151 | 151 |
| arrangement | observer side Polarizing plate/° | | | | | |
| conditions | Re of observer side First Retardation | 250 | 250 | 250 | 250 | 250 |
| of LCD | plate/nm | | | | | |
| | Azimuthal angle of Observer side First | 347 | 347 | 347 | 347 | 347 |
| | Retardation plate/nm | | | | | |
| | Re of Observer side Second Retardation | 97 | 97 | 97 | 97 | 97 |
| | plate/nm | | | | | |
| | Azimuthal angle of Observer side Second | 49 | 49 | 49 | 49 | 49 |
| | Retardation plate/nm | | | | | |
| | Azimuthal angle of director of | — | 225 | 45 | 225 | 45 |
| | Retardation layer/° | | | | | |
| | Alignment direction of LC layer/° | 45 | 45 | 45 | 45 | 45 |
| | Azimuthal angle of absorption axis of | 0 | 0 | 90 | 0 | 90 |
| | Backlight side Polarizing plate/° | | | | | |
| | Re of observer side Third Retardation | 99 nm | — | — | — | — |
| | plate/nm | | | | | |
| | Azimuthal angle of Observer side Third | 32 | — | — | — | — |
| | Retardation plate/nm | | | | | |
| | Re of observer side Forth Retardation | 258 nm | — | — | — | — |
| | plate/nm | | | | | |
| | Azimuthal angle of Observer side Forth | 107 | — | — | — | — |
| | Retardation plate/nm | | | | | |
| Evaluation | Mean contrast | 67 | 84 | 88 | 111 | 102 |
| results | Number of gray-scale inversion points | 13 | 30 | 39 | 20 | 25 |

According to the invention, it is possible to provide a transreflective type liquid crystal display, which can display images in both of reflective and transmissive modes, capable of displaying high brightness images with a wide-viewing angle, and excellent in productivity. According to the invention, it is no need to form a retardation film at the backlight-side; and it is possible to reduce the production cost.

What is claimed is:

1. A liquid crystal display comprising:
a backlight,
a pair of substrates,
a liquid crystal layer disposed between the pair of substrates,
a color filter,
reflective portions,
transmissive portions, and
a retardation layer disposed between the pair of substrates in each of the transmissive portions,
wherein the retardation layer comprises a liquid crystal material fixed in a hybrid state, and the retardation layer has a retardation which varies depending on a wavelength of the color filter.

2. The liquid crystal display of claim 1, wherein a phase angle of the retardation layer ranges from 50° to 130° depending on a wavelength of the color filter.

3. The liquid crystal display of claim 1, wherein the retardation layer has a first surface and a second surface, the first one being closer to one of the pair of substrates than the second one; and a tilt angle of the retardation layer increases along a direction going from the first surface to the second surface.

4. The liquid crystal display of claim 1, wherein the retardation layer has a first surface and a second surface, the first one being closer to one of the pair of substrates than the second one; and a tilt angle of the retardation layer decreases along a direction going from the first surface to the second surface.

5. The liquid crystal display of claim 1, wherein the retardation layer is disposed on one of the pair of the substrates, being closer to the backlight than another of the pair of the substrates.

6. The liquid crystal display of claim 1, wherein the retardation layer is disposed on one of the pair of the substrates, being closer to an observer side than another of the pair of the substrates.

7. The liquid crystal display of claim 1, wherein the retardation layer is disposed between the color filter and one of the pair of the substrates, being closer to an observer side than another of the pair of the substrates.

8. The liquid crystal display of claim 1, wherein the retardation layer is formed by fixing a nematic liquid crystal composition comprising a rod-like liquid crystal compound in a hybrid alignment state with a mean tilt angle ranging from 10 to 55°.

9. The liquid crystal display of claim 1, wherein the retardation layer is formed by fixing a smectic liquid crystal composition comprising a rod-like liquid crystal compound in a hybrid alignment state with a mean tilt angle ranging from 10 to 55°.

10. The liquid crystal display of claim 1, wherein the retardation layer is formed by fixing a nematic liquid crystal composition comprising a discotic liquid crystal compound in a hybrid alignment state with a mean tilt angle ranging from 35 to 85°.

11. The liquid crystal display of claim 1, wherein the retardation layer is formed of a polymerizable composition comprising a polymerizable liquid crystal compound having a polymerizable group(s), and a conversion of the polymerizable group (s) of the liquid crystal compound is equal to or more than 85%.

12. The liquid crystal display of claim 1, wherein a mean tilt angle of liquid crystal molecules in the liquid crystal layer in a black state is larger than that in a white state.

13. The liquid crystal display of claim 1, wherein a mean direction of directors of liquid crystal molecules in the liquid crystal layer projected on to a layer plane is substantially parallel to a mean direction of directors of liquid crystal molecules fixed in a hybrid alignment state in the retardation layer projected on to a layer plane.
